(19) United States
(12) Patent Application Publication
(10) Pub. No.: US 2026/0074821 A1
(43) Pub. Date: Mar. 12, 2026

(54) METHOD FOR DETERMINING MCS MAPPING INFORMATION, AND NETWORK DEVICE

(71) Applicant: GUANGDONG OPPO MOBILE TELECOMMUNICATIONS CORP., LTD., Dongguan (CN)

(72) Inventor: Zhe LIU, Dongguan (CN)

(21) Appl. No.: 19/389,609

(22) Filed: Nov. 14, 2025

Related U.S. Application Data
(63) Continuation of application No. PCT/CN2023/107584, filed on Jul. 14, 2023.

(51) Int. Cl. H04L 1/00

(52) U.S. Cl. CPC H04L 1/0003

(57) ABSTRACT

Provided are a method for determining modulation and coding scheme (MCS) mapping information and a network device. The method is performed by a terminal device and the method includes: determining MCS information of a channel based on transmission parameter information and an MCS mapping relationship, wherein the MCS mapping relationship includes at least one of a first mapping relationship and a second mapping relationship. The first mapping relationship includes MCS information corresponding to a scenario where the transmission parameter information indicates that a number of transmission layers of the channel is 1. The second mapping relationship includes MCS information corresponding to a scenario where the transmission parameter information indicates that a number of transmission layers of the channel is greater than or equal to 2. The first mapping relationship is different from the second mapping relationship.

### CROSS-REFERENCE TO RELATED APPLICATION

This application is a continuation of International Application No. PCT/CN2023/107584, filed Jul. 14, 2023, the entire disclosure of which is incorporated herein by reference.

### TECHNICAL FIELD

The present disclosure relates to the field of communications, and in particular, relates to a method for determining modulation and coding scheme (MCS) mapping information, and a network device.

### RELATED ART

Determination of an MCS is required for a channel over which data is transmitted. Typically, a corresponding modulation order and a corresponding target code rate are determined using an MCS index in an MCS mapping table.

### SUMMARY

Embodiments of the present disclosure provide a method for determining MCS mapping information, and a network device. The technical solutions are as follows.

According to some embodiments of the present disclosure, a method for determining MCS mapping information is provided. The method is performed by a terminal device, and includes: determining MCS information of a channel based on transmission parameter information and an MCS mapping relationship.

The MCS mapping relationship includes at least one of a first mapping relationship or a second mapping relationship. The first mapping relationship includes MCS information corresponding to a scenario where the transmission parameter information indicates that the number of transmission layers of the channel is 1. The second mapping relationship includes MCS information corresponding to a scenario where the transmission parameter information indicates that the number of transmission layers of the channel is greater than or equal to 2. The first mapping relationship is different from the second mapping relationship.

According to some embodiments of the present disclosure, a network device is provided. The network device includes: a processor; a transceiver communicably connected to the processor; and a memory configured to store one or more instructions executable by the processor. The processor is configured to load and execute the one or more instructions to transmit transmission parameter information, wherein the transmission parameter information is used with an MCS mapping relationship to determine MCS information of a channel.

The MCS mapping relationship includes at least one of a first mapping relationship or a second mapping relationship. The first mapping relationship includes MCS information corresponding to a scenario where the transmission parameter information indicates that the number of transmission layers of the channel is 1. The second mapping relationship includes MCS information corresponding to a scenario where the transmission parameter information indicates that the number of transmission layers of the channel is greater than or equal to 2. The first mapping relationship is different from the second mapping relationship.

### BRIEF DESCRIPTION OF DRAWINGS

For clearer illustration of the technical solutions according to the embodiments of the present disclosure, the drawings required in the description of the embodiments are described hereinafter briefly. Obviously, the drawings described herein are only some of the embodiments of the present disclosure. A person of ordinary skill in the art may derive other drawings based on these drawings without any creative efforts.

FIG. 1 is a schematic diagram of a mobile communication system according to some exemplary embodiments of the present disclosure;

FIG. 2 is a schematic flowchart of a method for determining MCS mapping information according to some exemplary embodiments of the present disclosure;

FIG. 3 is a schematic flowchart of a method for determining MCS mapping information according to some exemplary embodiments of the present disclosure;

FIG. 4 is a schematic flowchart of a method for determining MCS mapping information according to some exemplary embodiments of the present disclosure;

FIG. 5 is a schematic flowchart of a method for determining MCS mapping information according to some exemplary embodiments of the present disclosure;

FIG. 6 is a schematic flowchart of a method for determining MCS mapping information according to some exemplary embodiments of the present disclosure;

FIG. 7 is a schematic flowchart of a method for determining MCS mapping information according to some exemplary embodiments of the present disclosure;

FIG. 8 is a schematic flowchart of a method for determining MCS mapping information according to some exemplary embodiments of the present disclosure;

FIG. 9 is a schematic flowchart of a method for determining MCS mapping information according to some exemplary embodiments of the present disclosure;

FIG. 10 is a structural block diagram of an apparatus for determining MCS mapping information according to some exemplary embodiments of the present disclosure;

FIG. 11 is a structural block diagram of an apparatus for determining MCS mapping information according to some exemplary embodiments of the present disclosure; and

FIG. 12 is a structural schematic diagram of a communication device according to some exemplary embodiments of the present disclosure.

### DETAILED DESCRIPTION

For clearer descriptions of the objectives, technical solutions, and advantages of the present disclosure, some embodiments of the present disclosure are described hereinafter in detail with reference to the drawings. The exemplary embodiments are described in detail herein, and their examples are illustrated in the accompanying drawings. When the following description relates to the accompanying drawings, the same numerals in different drawings represent the like or similar elements, unless otherwise indicated. The embodiments illustrated in the following exemplary embodiments do not represent all the embodiments consistent with the present disclosure. Rather, these embodiments are merely examples of devices and methods that are consistent with some aspects of the present disclosure as detailed in the appended claims.

The terms used in the present disclosure are solely for the purpose of describing specific embodiments and are not intended to limit the present disclosure. The singular forms “a,” “an,” and “the” used in the present disclosure and the appended claims are also intended to encompass their plural forms, unless the context clearly indicates otherwise. It should also be understood that the term “and/or” as used herein refers to and includes any or all possible combinations of one or more of the associated listed items.

It should be understood that although terms such as “first,” “second,” and “third” may be used in the present disclosure to describe various information, such information should not be limited by these terms. These terms are only used to distinguish information of the same type from each other. For example, without departing from the scope of the present disclosure, first information may also be referred to as second information, and similarly, second information may also be referred to as first information. The term “if” as used herein may be interpreted as “when,” “upon,” or “in response to determining” depending on the context.

First, technologies related to the present disclosure are introduced hereinafter.

### 1. Determination of MCS Mapping Table

In the related art, in a case where a physical uplink shared channel (PUSCH) uses a discrete Fourier transform spread orthogonal frequency division multiplexing (DFT-s-OFDM) waveform for transmission, an MCS mapping table is determined as follows.
In a case where a parameter mcs-TableTransformPrecoderDCI-0-2 given by pusch-Config of radio resource control (RRC) signaling is configured as ‘qam256,’ a downlink control information (DCI) format of a physical downlink control channel (PDCCH) scheduling the PUSCH is DCI format 0_2, and a cyclic redundancy check (CRC) of the DCI is scrambled by a cell radio network temporary identifier (C-RNTI) or a semi-persistent channel state information RNTI (SP-CSI-RNTI), a user equipment (UE) determines a modulation order (denoted as “Qₘ”) and a target code rate (denoted as “R”) for the PUSCH based on an MCS index in Table 5.1.3.1-2 in Clause 5.1.3.1 of 3rd Generation Partnership Project (3GPP) TS 38.214.
In a case where a UE is not configured with an MCS-C-RNTI, a parameter mcs-TableTransformPrecoderDCI-0-2 given by pusch-Config is configured as ‘qam64LowSE,’ a DCI format of a PDCCH scheduling the PUSCH is DCI format 0_2, and a CRC of the DCI is scrambled by a C-RNTI or an SP-CSI-RNTI, the UE determines a modulation order (denoted as “Qₘ”) and a target code rate (denoted as “R”) for the PUSCH based on an MCS index in Table 6.1.4.1-2 in Clause 5.1.3.1 of 3GPP TS 38.214.
In a case where a parameter mcs-Table TransformPrecoder given by pusch-Config is configured as ‘qam256,’ a DCI format of a PDCCH scheduling the PUSCH is DCI format 0_1, and a CRC of the DCI is scrambled by a C-RNTI or an SP-CSI-RNTI, a UE determine a modulation order (denoted as “Qₘ”) and a target code rate (denoted as “R”) for the PUSCH based on an MCS index in Table 5.1.3.1-2 in Clause 5.1.3.1 of 3GPP TS 38.214.
In a case where a UE is not configured with an MCS-C-RNTI, a parameter mcs-Table TransformPrecoder given by pusch-Config is configured as ‘qam64LowSE,’ a DCI format of a PDCCH scheduling the PUSCH is a format other than DCI format 0_2 in a UE-specific search space, and a CRC of the DCI is scrambled by a C-RNTI or an SP-CSI-RNTI, the UE determines a modulation order (denoted as “Qₘ”) and a target code rate (denoted as “R”) for the PUSCH based on an MCS index in Table 6.1.4.1-2 in Clause 5.1.3.1 of 3GPP TS 38.214 to.
In a case where a UE is configured with an MCS-C-RNTI, and a CRC of a PDCCH scheduling the PUSCH is scrambled by the MCS-C-RNTI, the UE determines a modulation order (denoted as “Qₘ”) and a target code rate (denoted as “R”) for the PUSCH based on an MCS index in Table 6.1.4.1-2 in Clause 5.1.3.1 of 3GPP TS 38.214.

In a case where a parameter mcs-TableTransformPrecoder given by configuredGrantConfig of RRC signaling is configured as ‘qam256,’ and a CRC of a PDCCH scheduling the PUSCH is scrambled by a CS-RNTI or the PUSCH is transmitted with configured grant, a UE determines a modulation order (denoted as “Qₘ”) and a target code rate (denoted as “R”) for the PUSCH based on an MCS index in Table 5.1.3.1-2 in Clause 5.1.3.1 of 3GPP TS 38.214.
In a case where a parameter mcs-TableTransformPrecoder given by configuredGrantConfig of RRC signaling is configured as ‘qam64LowSE,’ and a CRC of a PDCCH scheduling the PUSCH is scrambled by a CS-RNTI or the PUSCH is transmitted with configured grant, a UE determines a modulation order (denoted as “Qₘ”) and a target code rate (denoted as “R”) for the PUSCH by using an MCS index in Table 6.1.4.1-2 in Clause 5.1.3.1 of 3GPP TS 38.214.
In a case where MsgA-PUSCH transmission is performed, a UE determines a target code rate for the MsgA-PUSCH based on an MCS index indicated by a high-layer parameter msgA-MCS and Table 6.1.4.1-2 in Clause 5.1.3.1 of 3GPP TS 38.214, wherein q is equal to 2 for Table 6.1.4.1-2.
In a case where the PUSCH transmission is not MsgA-PUSCH transmission, a UE determines a modulation order (denoted as “Qₘ”) and a target code rate (denoted as “R”) for the PUSCH transmission based on an MCS index in Table 6.1.4.1-1 in Clause 5.1.3.1 of 3GPP TS 38.214.

### 2. DFT-s-OFDM Waveform and Cyclic Prefix Orthogonal Frequency Division Multiplexing (CP-OFDM) Waveform

Application scenarios of DFT-s-OFDM waveforms differ from application scenarios of CP-OFDM waveforms.

In the related art, under the DFT-s-OFDM waveform, PUSCH transmission scheduled by a control channel should be single-layer PUSCH transmission to ensure single-carrier characteristics. The CP-OFDM waveform supports multi-layer PUSCH transmission, and the multi-layer uplink transmission under the CP-OFDM waveform enhances system capacity.

Considering that the multi-layer uplink transmission improves uplink coverage and throughput, the multi-layer uplink transmission may be introduced under the DFT-s-OFDM waveform to enhance uplink transmission performance in DFT-s-OFDM waveform scenarios.

In Table 5.1.3.1-2 and Table 6.1.4.1-2 in Clause 5.1.3.1 of 3GPP TS 38.214 as described above, two MCS mapping tables with a highest modulation order of 64QAM correspond to high spectral efficiency and low spectral efficiency, respectively, in the DFT-s-OFDM waveform scenarios.

However, under the DFT-s-OFDM waveform, the MCS mapping tables as described above, when used for the PUSCH with two or more transmission layers, may reduce demodulation performance of the PUSCH, and is not conducive to enhancing uplink coverage.

In view of the above problems, the present disclosure provides a method for determining MCS mapping information. This method supports determining an appropriate MCS mapping table for PUSCH transmission with two or more transmission layers under the DFT-s-OFDM waveform.

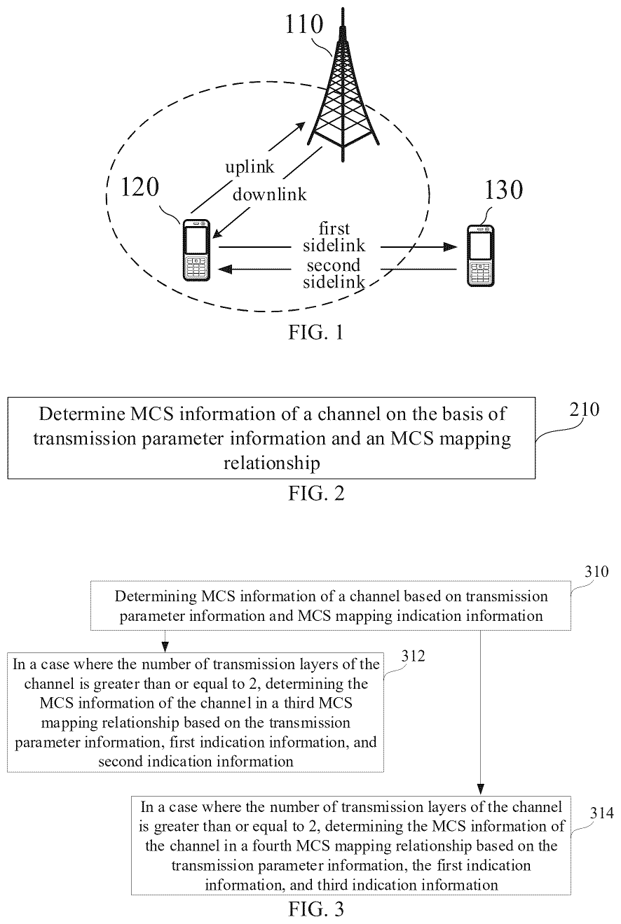

FIG. 1 illustrates a schematic diagram of a mobile communication system according to some exemplary embodiments of the present disclosure. The mobile communication system includes a network device 110 and a terminal device 120. The mobile communication system may include or may not include a terminal device 130, which is not limited in the present disclosure.

The network device 110 in the present disclosure provides wireless communication functions. The network device 110 includes but is not limited to: an evolved Node-B (eNB), a radio network controller (RNC), a Node-B (NB), a base station controller (BSC), a base transceiver station (BTS), a home base station (e.g., a home evolved Node B or a home Node-B, HNB), a baseband unit (BBU), an access point (AP) in a wireless fidelity (Wi-Fi) system, a wireless relay node, a wireless backhaul node, a transmission point (TP) or a transmission and reception point (TRP), or the like. The network device 110 may also be a next generation Node-B (gNB) or a transmission point (TRP or TP) in a 5^{th} generation (5G) mobile communication system, one or a group of (including a plurality of antenna panels) antenna panels of a base station in the 5G system, a network node constituting a gNB or a transmission point, such as a BBU or a distributed unit (DU), or a base station in a beyond-fifth generation (B5G) or 6^{th} generation (6G) mobile communication system, or the like. The network device 110 may refer to a core network (CN), fronthaul, backhaul, a radio access network (RAN), a network slice, or the like; or a serving cell, a primary cell (PCell), a primary secondary cell (PSCell), a special cell (SpCell), a secondary cell (SCell), or a neighboring cell of the terminal device, or the like.

The terminal device 120 in the present disclosure is also referred to as a UE, an access terminal, a subscriber unit, a subscriber station, a mobile site, a mobile station, a remote station, remote terminal, a mobile device, a user terminal, a terminal, a wireless communication device, a user agent, or a user device. The terminal device includes but is not limited to: a handheld device, a wearable device, a vehicle-mounted device, and an Internet of things (IoT) device, such as a mobile phone, a tablet computer, an e-book reader, a laptop computer, a desktop computer, a TV, a game console, a mobile Internet device (MID), an augmented reality (AR) terminal, a virtual reality (VR) terminal, a mixed reality (MR) terminal, an extended reality (XR) terminal, a baffle reality (BR) terminal, a cinematic reality (CR) terminal, a deceive reality (DR) terminal, a wearable device, a handle, an electronic tag, a controller, a wireless terminal in industrial control, a wireless terminal in self-driving, a wireless terminal in remote medical technology, a wireless terminal in smart grid, a wireless terminal in transportation safety, a wireless terminal in smart city, a wireless terminal in smart home, a wireless terminal in remote medical surgery, a cellular phone, a cordless phone, a Session Initiation Protocol (SIP) phone, a wireless local loop (WLL) station, a personal digital assistant (PDA), a set-top box (STB), or a customer premises equipment (CPE), or the like.

The network device 110 and the terminal device 120 communicate with each other via an air interface technology, such as a Uu interface.

Exemplarily, two communication scenarios are present between the network device 110 and the terminal device 120, namely, an uplink communication scenario and a downlink communication scenario. The uplink communication (or called uplink transmission) refers to signal or data transmission to the network device 110. The downlink communication (or called downlink transmission) refers to signal or data transmission to the terminal device 120.

The terminal device 120 and the terminal device 130 communicate with each other via an air interface technology, such as a Uu interface.

In some embodiments, two communication scenarios are present between the terminal device 120 and the terminal device 130, namely, a first sidelink communication scenario and a second sidelink communication scenario. The first sidelink communication refers to transmitting signals to the terminal device 130. The second sidelink communication refers to transmitting signals to the terminal device 120.

Both the terminal device 120 and the terminal device 130 are within the network coverage and located in the same cell, or both the terminal device 120 and the terminal device 130 are within the network coverage but located in different cells, or the terminal device 120 is within the network coverage but the terminal device 130 is outside the network coverage.

The technical solutions according to the embodiments of the present disclosure is applicable to various communication systems, such as, a global system of mobile communication (GSM) system, a code-division multiple access (CDMA) system, a wideband code-division multiple access (WCDMA) system, a general packet radio service (GPRS), a long-term evolution (LTE) system, an LTE frequency-division duplex (FDD) system, an LTE time-division duplex (TDD) system, an advanced long-term evolution (LTE-A) system, a universal mobile telecommunication system (UMTS), a worldwide interoperability for microwave access (WiMAX) communication system, a 5G mobile communication system, a new radio (NR) system, an evolved system of the NR system, an LTE-based access to unlicensed spectrum (LTE-U) system, an NR-based access to unlicensed spectrum (NR-U) system, a terrestrial network (TN) system, a non-terrestrial network (NTN) system, a wireless local area network (WLAN), a Wi-Fi system, a cellular IoT system, or a cellular passive IoT system. The technical solutions according to the embodiments of the present disclosure may also be applied to an evolved system of the 5G NR system, as well as B5G, 6G and subsequent evolved systems. In some embodiments of the present disclosure, “NR” may also be referred to as a 5G NR system or a 5G system. The 5G mobile communication system may include non-standalone (NSA) and/or standalone (SA).

The technical solutions according to the embodiments of the present disclosure may also be applied to a machine-type communication (MTC), a long-erm evolution-machine (LTE-M), a device-to-device (D2D) network, a machine-to-machine (M2M) network, an IoT network or other networks. The IoT network may include, for example, a vehicle-to-everything (V2X) network. Communication methods in a V2X network system are collectively referred to as vehicle-to-X (i.e., V2X, where X represents any object). For example, the V2X may include: vehicle-to-vehicle (V2V) communications, vehicle-to-infrastructure (V2I) communications, vehicle-to-pedestrian (V2P) communications, or vehicle-to-network (V2N) communications, or the like.

The mobile communication system according to the embodiments of the present disclosure is applicable to, but not limited to, at least one of: an uplink communication scenario, a downlink communication scenario, or a sidelink communication scenario.

FIG. 2 illustrates a schematic flowchart of a method for determining MCS mapping information according to some exemplary embodiments of the present disclosure. Illustrative description is given by using an example where the method is performed by the terminal device in FIG. 1. The method includes at least some of the following steps.

In step 210, the terminal device determines MCS information of a channel based on transmission parameter information and an MCS mapping relationship.

The transmission parameter information is transmission parameter information directed to the channel and is used to indicate transmission parameters of the channel. The transmission parameters include one or more of: the number of transmission layers, a coding parameter, a modulation parameter, or other parameters.

The MCS mapping relationship includes at least one of: a first mapping relationship or a second mapping relationship. The first mapping relationship includes MCS information corresponding to a scenario where the transmission parameter information indicates that the number of transmission layers of the channel is 1. The second mapping relationship includes MCS information corresponding to a scenario where the transmission parameter information indicates that the number of transmission layers of the channel is greater than or equal to 2. The first mapping relationship is different from the second mapping relationship.

In some embodiments, the MCS mapping relationship is specified by a communication protocol or configured by a network device.

In some embodiments, prior to performing step 210, the terminal device receives the transmission parameter information from a network device. In some embodiments, the number of transmission layers of the channel is explicitly or implicitly indicated by the transmission parameter information. In some embodiments, a specific manner of implicit indication may be specified by a communication protocol, configured by a network device, or determined via negotiation between the network device and the terminal device.

In some embodiments, the first mapping relationship includes at least two types of mapping relationships.

In some embodiments, the second mapping relationship includes at least two types of mapping relationships; or the second mapping relationship includes at least four types of mapping relationships.

In some embodiments, the MCS mapping relationship includes one or more of information elements such as an MCS index, a target code rate, a modulation order, and a spectral efficiency. In some embodiments, the MCS index has a mapping relationship with the target code rate, a mapping relationship with the modulation order, and a mapping relationship with the spectral efficiency. In some embodiments, the mapping relationship between the MCS index and the target code rate, the mapping relationship between the MCS index and the modulation order, and the mapping relationship between the MCS index and the spectral efficiency are stored in the form of an MCS mapping table.

The MCS information refers to the MCS information used during channel transmission, including one or more of information elements such as the modulation order, the target code rate, and the spectral efficiency.

It should be understood that in the present disclosure, “transmission” may refer to either sending or receiving, or include both sending and receiving operations.

In view of the above, the method according to the embodiments of the present disclosure enables the determination of corresponding MCS information for channels with different numbers of transmission layers based on the transmission parameter of the channel and the MCS mapping relationship. Compared with a design in the related art where the same MCS mapping table is used regardless of the number of transmission layers of the channel, the method according to the embodiments of the present disclosure supports determining more accurate and appropriate MCS information for channels with different numbers of transmission layers. This improves demodulation performance of the channel, enhances coverage and transmission quality of the channel, and improves communication efficiency of a communication system.

On the basis of the example illustrated in FIG. 2, step 210 may also be implemented as step 310. FIG. 3 illustrates a schematic flowchart of a method for determining MCS mapping information according to some exemplary embodiments of the present disclosure. Illustrative description is given by using an example where the method is performed by the terminal device in FIG. 1. The method includes at least some of the following steps.

In step 310, the terminal device determines MCS information of a channel based on transmission parameter information and MCS mapping indication information.

The transmission parameter information is transmission parameter information directed to the channel and is used to indicate transmission parameters of the channel. The transmission parameters include one or more of: the number of transmission layers, a coding parameter, a modulation parameter, or other parameters.

In some embodiments, prior to performing step 310, the terminal device receives the transmission parameter information from a network device. In some embodiments, the number of transmission layers of the channel is explicitly or implicitly indicated by the transmission parameter information. In some embodiments, a specific manner of implicit indication may be specified by a communication protocol, configured by a network device, or determined via negotiation between the network device and the terminal device.

The MCS mapping indication information is used to indicate an MCS mapping relationship.

In some embodiments, prior to performing step 310, the terminal device receives the MCS mapping indication information from a network device.

In some embodiments, the MCS mapping relationship includes at least one of: a first mapping relationship or a second mapping relationship. The first mapping relationship includes MCS information corresponding to a scenario where the transmission parameter information indicates that the number of transmission layers of the channel is 1. The second mapping relationship includes MCS information corresponding to a scenario where the transmission parameter information indicates that the number of transmission layers of the channel is greater than or equal to 2. The first mapping relationship is different from the second mapping relationship.

In some embodiments, the MCS mapping relationship is specified by a communication protocol or configured by a network device.

In some embodiments, the MCS mapping relationship includes one or more of information elements such as an MCS index, a target code rate, a modulation order, and a spectral efficiency. In some embodiments, the MCS index has a mapping relationship with the target code rate, a mapping relationship with the modulation order, and a mapping relationship with the spectral efficiency. In some embodiments, the mapping relationship between the MCS index and the target code rate, the mapping relationship between the MCS index and the modulation order, and the mapping relationship between the MCS index and the spectral efficiency are stored in the form of an MCS mapping table.

In some embodiments, the first mapping relationship includes at least one of: a first MCS mapping relationship or a second MCS mapping relationship; and the second mapping relationship includes at least one of: a third MCS mapping relationship or a fourth MCS mapping relationship.

The first MCS mapping relationship, the second MCS mapping relationship, the third MCS mapping relationship, and the fourth MCS mapping relationship are different from each other.

In some embodiments, the MCS mapping indication information includes first indication information. In some embodiments, the first indication information is used to indicate that transform precoding is enabled. In some embodiments, the first indication information is used to indicate that channel transmission adopts a DFT-s-OFDM waveform. In some embodiments, the first indication information is used to indicate switching from a CP-OFDM waveform to the DFT-s-OFDM waveform. In some embodiments, the first indication information is used to indicate that precoding is enabled for the channel transmission. In some embodiments, the first indication information is used to indicate that the channel transmission is performed via precoding, where the MCS mapping relationship includes a mapping relationship associated with the channel transmission via precoding.

In some embodiments, “determining the MCS information of the channel based on the transmission parameter information and the MCS mapping indication information” may be implemented as “determining the MCS information of the channel based on the transmission parameter information and the first indication information.”

In some embodiments, prior to performing step 310, the terminal device receives the first indication information from a network device. In some embodiments, the first indication information is carried by one or more of: RRC signaling, a medium access control (MAC) control element (CE), or DCI. In some embodiments, the first indication information is configured in: a parameter msg3-transformPrecoder, a parameter msgA-TransformPrecoder, a parameter transformPrecoder in a parameter pusch-Config, or a parameter transformPrecoder in a parameter configuredGrantConfig.

In some embodiments, in a case where the number of transmission layers of the channel is 1, the relevant determination methods in “1. Determination of MCS Mapping Table” as described above may be adopted.

In some embodiments, the MCS mapping indication information further includes second indication information or third indication information. Accordingly, step 310 may also be implemented as step 312 or step 314.

In step 312, in a case where the number of transmission layers of the channel is greater than or equal to 2, the terminal device determines the MCS information of the channel in a third MCS mapping relationship based on the transmission parameter information, the first indication information, and second indication information.

In some embodiments, step 312 may also be implemented as follows: in a case where the transmission parameter information indicates that the number of transmission layers of the channel is greater than or equal to 2, and the MCS mapping indication information includes the first indication information and the second indication information, the terminal device determines the MCS information of the channel based on the third MCS mapping relationship.

The second indication information is used to indicate a first quadrature amplitude modulation (QAM) scheme. In some embodiments, the first QAM scheme includes one or more of: a QAM64 scheme, a non-QAM256 scheme, or a non-QAM64 scheme with low spectral efficiency (i.e., a non-QAM64LowSE scheme).

In some embodiments, the second indication information is used to indicate the QAM64 scheme; or the second indication information is not used to indicate a QAM256 scheme or a QAM64LowSE scheme.

In some embodiments, the second indication information includes a parameter configured as ‘QAM64,’ or excludes a parameter configured as ‘QAM256,’ or excludes a parameter configured as ‘QAM64LowSE.’

In some embodiments, in the third MCS mapping relationship, a target code rate is 438 for an MCS index of 17.

In some embodiments, the second indication information is carried in RRC signaling or a MAC CE.

The second indication information is transmitted by a network device.

In some embodiments, prior to performing step 312, the terminal device receives the second indication information from the network device.

In step 314, in a case where the number of transmission layers of the channel is greater than or equal to 2, the terminal device determines the MCS information of the channel in a fourth MCS mapping relationship based on the transmission parameter information, the first indication information, and third indication information.

In some embodiments, step 314 may also be implemented as follows: in a case where the transmission parameter information indicates that the number of transmission layers of the channel is greater than or equal to 2, and the MCS mapping indication information includes the first indication information and the third indication information, the terminal device determines the MCS information of the channel based on the fourth MCS mapping relationship.

The third indication information is used to indicate a second QAM scheme. In some embodiments, the second QAM scheme includes a QAM64LowSE scheme.

In some embodiments, the third indication information is used to indicate the QAM64LowSE scheme.

In some embodiments, the third indication information includes a parameter configured as ‘QAM64LowSE.’

In some embodiments, in the fourth MCS mapping relationship, a target code rate is 438 for an MCS index of 21; and/or a target code rate is 466 for an MCS index of 22; and/or a target code rate is 517 for an MCS index of 23.

In some embodiments, the third indication information is carried in RRC signaling or a MAC CE.

The third indication information is transmitted by a network device.

In some embodiments, prior to performing step 314, the terminal device receives the third indication information from the network device.

In view of the above, the method according to the embodiments of the present disclosure supports determining different MCS information for channels with different numbers of transmission layers based on the number of transmission layers of the channel and whether the channel transmission is performed via precoding. Compared with a design in the related art where the same MCS mapping table is used regardless of the number of transmission layers of the channel, the method according to the embodiments of the present disclosure supports determining more accurate and appropriate MCS information for channels with different numbers of transmission layers. This improves demodulation performance of the channel, enhances coverage and transmission quality of the channel, and improves communication efficiency of a communication system. Moreover, the method further supports matching the MCS mapping relationship for determining the MCS information to the channel based on the second indication information or the third indication information, thereby further improving the accuracy and appropriateness of the determination of the MCS mapping information. In this way, the method according to the embodiments of the present disclosure provides two granularities of methods for determining MCS mapping information, which achieves high flexibility and strong robustness and meets requirements for determining MCS mapping tables in various communication scenarios.

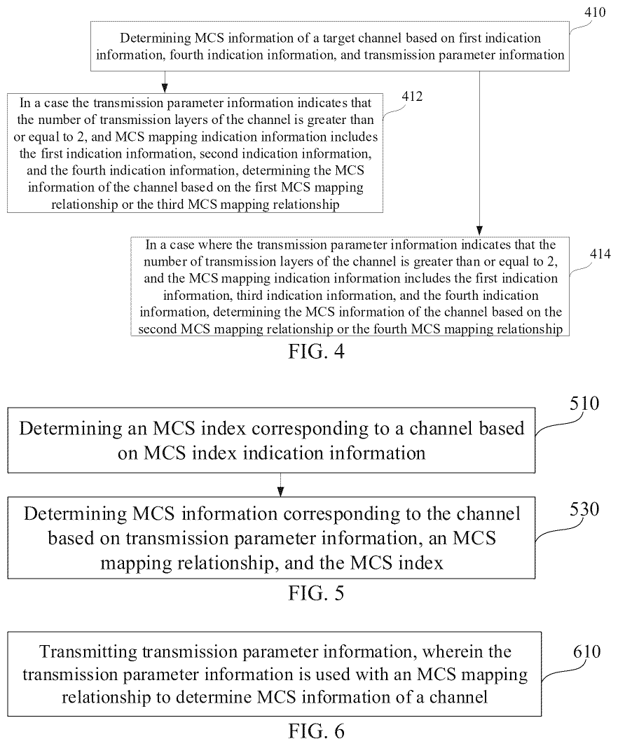

On the basis of the example illustrated in FIG. 3, step 310 may also be implemented as step 410. FIG. 4 illustrates a schematic flowchart of a method for determining MCS mapping information according to some exemplary embodiments of the present disclosure. Illustrative description is given by using an example where the method is performed by the terminal device in FIG. 1. The method includes at least some of the following steps.

In step 410, the terminal device determines MCS information of a channel based on first indication information, fourth indication information, and transmission parameter information.

The transmission parameter information is the transmission parameter information directed to the channel and is used to indicate transmission parameters of the channel. The transmission parameters include one or more of: the number of transmission layers, a coding parameter, a modulation parameter, or other parameters.

In some embodiments, prior to performing step 410, the terminal device receives the transmission parameter information from a network device. In some embodiments, the number of transmission layers of the channel is explicitly or implicitly indicated by the transmission parameter information. In some embodiments, a specific manner of implicit indication may be specified by a communication protocol, configured by a network device, or determined via negotiation between the network device and the terminal device.

MCS mapping indication information is used to indicate an MCS mapping relationship.

In some embodiments, prior to performing step 410, the terminal device receives the MCS mapping indication information from a network device.

In some embodiments, the MCS mapping relationship includes at least one of: a first mapping relationship or a second mapping relationship. The first mapping relationship includes MCS information corresponding to a scenario where the transmission parameter information indicates that the number of transmission layers of the channel is 1. The second mapping relationship includes MCS information corresponding to a scenario where the transmission parameter information indicates that the number of transmission layers of the channel is greater than or equal to 2. The first mapping relationship is different from the second mapping relationship.

In some embodiments, the MCS mapping relationship is specified by a communication protocol or configured by a network device.

In some embodiments, the MCS mapping relationship includes one or more of information elements such as an MCS index, a target code rate, a modulation order, and a spectral efficiency. In some embodiments, the MCS index has a mapping relationship with the target code rate, a mapping relationship with the modulation order, and a mapping relationship with the spectral efficiency. In some embodiments, the mapping relationship between the MCS index and the target code rate, the mapping relationship between the MCS index and the modulation order, and the mapping relationship between the MCS index and the spectral efficiency are stored in the form of an MCS mapping table.

In some embodiments, the first mapping relationship includes at least one of: a first MCS mapping relationship or a second MCS mapping relationship; and the second mapping relationship includes one or more of: the first MCS mapping relationship, the second MCS mapping relationship, a third MCS mapping relationship, and a fourth MCS mapping relationship.

The first MCS mapping relationship, the second MCS mapping relationship, the third MCS mapping relationship, and the fourth MCS mapping relationship are different from each other.

In some embodiments, the MCS mapping indication information includes the first indication information and the fourth indication information.

In some embodiments, the first indication information is used to indicate that transform precoding is enabled. In some embodiments, the first indication information is used to indicate that channel transmission adopts a DFT-s-OFDM waveform. In some embodiments, the first indication information is used to indicate switching from a CP-OFDM waveform to the DFT-s-OFDM waveform. In some embodiments, the first indication information is used to indicate that precoding is enabled for the channel transmission. In some embodiments, the first indication information is used to indicate that the channel transmission is performed via precoding, where the MCS mapping relationship includes a mapping relationship associated with the channel transmission via precoding.

In some embodiments, a value of the fourth indication information is used to indicate the MCS mapping relationship.

In some embodiments, “determining the MCS information of the channel based on the transmission parameter information and the MCS mapping indication information” may be implemented as “determining the MCS information of the channel based on the transmission parameter information, the first indication information, and the fourth indication information.”

In some embodiments, prior to performing step 410, the terminal device receives the first indication information from a network device. In some embodiments, the first indication information is carried by one or more of: RRC signaling, a MAC CE, or DCI. In some embodiments, the first indication information is configured in: a parameter msg3-transformPrecoder, a parameter msgA-TransformPrecoder, a parameter transformPrecoder in a parameter pusch-Config, or a parameter transformPrecoder in a parameter configuredGrantConfig.

In some embodiments, in a case where the number of transmission layers of the channel is 1, the relevant determination methods in “1. Determination of MCS Mapping Table” as described above may be adopted.

In some embodiments, the MCS mapping indication information further includes second indication information or third indication information. Therefore, step 410 may also be implemented as step 412 or step 414.

In step 412, in a case the transmission parameter information indicates that the number of transmission layers of the channel is greater than or equal to 2, and the MCS mapping indication information includes the first indication information, the second indication information, and the fourth indication information, the terminal device determines the MCS information of the channel based on the first MCS mapping relationship or the third MCS mapping relationship.

In some embodiments, step 412 may also be implemented as follows: in a case where the number of transmission layers of the channel is greater than or equal to 2, the terminal device determines the MCS information of the channel in the first MCS mapping relationship or the third MCS mapping relationship based on the transmission parameter information, the first indication information, the second indication information, and the fourth indication information.

The second indication information is used to indicate a first QAM scheme. In some embodiments, the first QAM scheme includes one or more of: a QAM64 scheme, a non-QAM256 scheme, or a non-QAM64LowSE scheme.

In some embodiments, the second indication information is used to indicate the QAM64 scheme; or the second indication information is not used to indicate a QAM256 scheme or a QAM64LowSE scheme.

In some embodiments, the second indication information includes a parameter configured as ‘QAM64,’ or excludes a parameter configured as ‘QAM256,’ or excludes a parameter configured as ‘QAM64LowSE.’

In some embodiments, in the first MCS mapping relationship, a target code rate is 658 for an MCS index of 16, and/or a target code rate is 466 for an MCS index of 17.

In some embodiments, in the third MCS mapping relationship, a target code rate is 438 for an MCS index of 17.

In some embodiments, the second indication information is carried in RRC signaling or a MAC CE.

The second indication information is transmitted by a network device.

In some embodiments, prior to performing step 412, the terminal device receives the second indication information from the network device.

In some embodiments, in a case where the transmission parameter information indicates that the number of transmission layers of the channel is greater than or equal to 2, the MCS mapping indication information includes the first indication information, the second indication information, and the fourth indication information, and the fourth indication information takes a first value, the MCS information of the channel is determined based on the first MCS mapping relationship.

In some embodiments, in a case where the transmission parameter information indicates that the number of transmission layers of the channel is greater than or equal to 2, the MCS mapping indication information includes the first indication information, the second indication information, and the fourth indication information, and the fourth indication information takes a second value, the MCS information of the channel is determined based on the third MCS mapping relationship.

Exemplarily, the first value is 0 or another number, and the second value is 1 or another number; or the first value is 1 or another number, and the second value is 0 or another number.

In step 414, in a case where the transmission parameter information indicates that the number of transmission layers of the channel is greater than or equal to 2, and the MCS mapping indication information includes the first indication information, the third indication information, and the fourth indication information, the terminal device determines the MCS information of the channel based on the second MCS mapping relationship or the fourth MCS mapping relationship.

In some embodiments, step 414 may also be implemented as follows: in a case where the number of transmission layers of the channel is greater than or equal to 2, the terminal device determines the MCS information of the channel in the second MCS mapping relationship or the fourth MCS mapping relationship based on the transmission parameter information, the first indication information, the third indication information, and the fourth indication information.

The third indication information is used to indicate a second QAM scheme. In some embodiments, the second QAM scheme includes a QAM64LowSE scheme.

In some embodiments, the third indication information is used to indicate the QAM64LowSE scheme.

In some embodiments, the third indication information includes a parameter configured as ‘QAM64LowSE.’

In some embodiments, in the second MCS mapping relationship, a target code rate is 658 for an MCS index of 21; and/or a target code rate is 699 for an MCS index of 22; and/or a target code rate is 772 for an MCS index of 23.

In some embodiments, in the fourth MCS mapping relationship, a target code rate is 438 for an MCS index of 21; and/or a target code rate is 466 for an MCS index of 22; and/or a target code rate is 517 for an MCS index of 23.

In some embodiments, the third indication information is carried in RRC signaling or a MAC CE.

The third indication information is transmitted by a network device.

In some embodiments, prior to performing step 414, the terminal device receives the third indication information from the network device.

In some embodiments, in a case where the transmission parameter information indicates that the number of transmission layers of the channel is greater than or equal to 2, the MCS mapping indication information includes the first indication information, the third indication information, and the fourth indication information, and the fourth indication information takes a first value, the MCS information of the channel is determined based on the second MCS mapping relationship.

In some embodiments, in a case where the transmission parameter information indicates that the number of transmission layers of the channel is greater than or equal to 2, the MCS mapping indication information includes the first indication information, the third indication information, and the fourth indication information, and the fourth indication information takes a second value, the MCS information of the channel is determined based on the fourth MCS mapping relationship.

Exemplarily, the first value is 0 or another number, and the second value is 1 or another number; or the first value is 1 or another number, and the second value is 0 or another number.

In view of the above, the method according to the embodiments of the present disclosure supports determining different MCS information for channels with different numbers of transmission layers based on the number of transmission layers of the channel, the fourth indication information, and whether the channel transmission is performed via precoding. Compared with a design in the related art where the same MCS mapping table is used regardless of the number of transmission layers of the channel, the method according to the embodiments of the present disclosure supports determining more accurate and appropriate MCS information for channels with different numbers of transmission layers. This improves demodulation performance of the channel, enhances coverage and transmission quality of the channel, and improves communication efficiency of a communication system. Moreover, the method supports further matching the MCS mapping relationship for determining the MCS information to the channel based on the second indication information or the third indication information, thereby further improving the accuracy and appropriateness of the determination of the MCS mapping information. In this way, the method according to the embodiments of the present disclosure provides three granularities of methods for determining MCS mapping information, which achieves high flexibility and strong robustness and meets requirements for determining MCS mapping tables in various communication scenarios.

On the basis of the example illustrated in FIG. 2, step 210 may be implemented as step 510 and step 530. FIG. 5 illustrates a schematic flowchart of a method for determining MCS mapping information according to some exemplary embodiments of the present disclosure. Illustrative description is given by using an example where the method is performed by the terminal device in FIG. 1. The method includes at least some of the following steps.

In step 510, the terminal device determines an MCS index corresponding to a channel based on MCS index indication information.

The MCS index corresponding to the channel refers to an MCS index of the channel in an MCS mapping relationship.

In some embodiments, the terminal device determines, based on the MCS index indication information, a target row, a target column, or a target element corresponding to the channel in the MCS mapping relationship. Herein, the element may be understood as an entry or a table cell.

In some embodiments, the MCS index indication information is carried in DCI.

In step 530, the terminal device determines MCS information corresponding to the channel based on transmission parameter information, an MCS mapping relationship, and the MCS index.

The MCS information includes one or more of: a modulation order, a target code rate, or a spectral efficiency.

In some embodiments, the channel includes one PUSCH.

In some embodiments, the channel includes at least two PUSCHs, and the at least two PUSCHs include a first PUSCH and a second PUSCH.

The first PUSCH includes at least one PUSCH associated with first spatial information, the second PUSCH includes at least one PUSCH associated with second spatial information, and the first spatial information is different from the second spatial information.

In some embodiments, a transmission scheme of the channel includes a space-division multiplexing (SDM) scheme or a single-frequency network (SFN) scheme.

In some embodiments, an MCS mapping relationship corresponding to the first PUSCH is the same as or different from an MCS mapping relationship corresponding to the second PUSCH.

In some embodiments, the MCS mapping relationships corresponding to the first PUSCH and the second PUSCH are set uniformly or separately.

In some embodiments, an MCS index corresponding to the first PUSCH is the same as or different from an MCS index corresponding to the second PUSCH.

In some embodiments, the MCS indexes corresponding to the first PUSCH and the second PUSCH are set uniformly or separately.

In some embodiments, the MCS index indication information includes first MCS index indication information and second MCS index indication information. The MCS index corresponding to the first PUSCH is determined based on the first MCS index indication information, and the MCS index corresponding to the second PUSCH is determined based on the second MCS index indication information. It may also be understood that the first MCS index indication information is used to determine the MCS index corresponding to the first PUSCH, and the second MCS index indication information is used to determine the MCS index corresponding to the second PUSCH.

In some embodiments, the MCS index indication information includes first MCS index indication information. The MCS index corresponding to the first PUSCH is determined based on the first MCS index indication information, and the MCS index corresponding to the second PUSCH is determined based on the first MCS index indication information and a first offset value. It may also be understood that the first MCS index indication information is used to determine the MCS index corresponding to the first PUSCH, and the first MCS index indication information and the first offset value are used to determine the MCS index corresponding to the second PUSCH.

In some embodiments, a value of the MCS index corresponding to the second PUSCH is a sum of the first offset value and a value of the MCS index corresponding to the first PUSCH.

It should be understood that the example illustrated in FIG. 5 may be used independently or in combination with the example illustrated in FIG. 3 or FIG. 4. For example, in a case where the example illustrated in FIG. 5 is used in combination with the example illustrated in FIG. 3, the terminal device determines, upon determination of the MCS mapping relationship of the channel according to the method illustrated in FIG. 3, the MCS index corresponding to the channel according to the method illustrated in FIG. 5. For example, in a case where the example illustrated in FIG. 5 is used in combination with the example illustrated in FIG. 4, the terminal device determines, upon determination of the MCS mapping relationship of the channel according to the method illustrated in FIG. 4, the MCS index corresponding to the channel according to the method illustrated in FIG. 5.

In view of the above, the method according to the embodiments of the present disclosure enables determination of different MCS mapping relationships for channels with different numbers of transmission layers based on the transmission parameter information of the channel. Compared with a design in the related art where the same MCS mapping table is used regardless of the number of transmission layers of the channel, the method according to the embodiments of the present disclosure supports determining more accurate and appropriate MCS information for channels with different numbers of transmission layers. This improves demodulation performance of the channel, enhances coverage and transmission quality of the channel, and improves communication efficiency of a communication system. In a case where the number of transmission layers is greater than or equal to 2, the first PUSCH and the second PUSCH are set to use at least one of the same MCS mapping relationship or the same MCS index, and thus, transmission resources are saved, and the load of DCI used for scheduling the first PUSCH and the second PUSCH is reduced. In a case where the MCS mapping relationships and/or the MCS indexes of the first PUSCH and the second PUSCH are set separately, the channel transmission achieves greater adaptability, improved demodulation performance, and enhanced efficiency, thereby effectively improving the transmission performance of a communication system.

FIG. 6 illustrates a schematic flowchart of a method for determining MCS mapping information according to some exemplary embodiments of the present disclosure. Illustrative description is given by using an example where the method is performed by a network device illustrated in FIG. 1. The method includes at least some of the following steps.

In step 610, the network device transmits transmission parameter information, wherein the transmission parameter information is used with an MCS mapping relationship to determine MCS information of a channel.

The transmission parameter information is transmission parameter information directed to the channel and is used to indicate transmission parameters of the channel. The transmission parameters include one or more of: the number of transmission layers, a coding parameter, a modulation parameter, or other parameters.

The transmission parameter information is transmitted by the network device to a terminal device. In some embodiments, the transmission parameter information is transmitted in a unicast, multicast, or broadcast manner. In some embodiments, the number of transmission layers of the channel is explicitly or implicitly indicated by the transmission parameter information. In some embodiments, a specific manner of implicit indication may be specified by a communication protocol, configured by the network device, or determined via negotiation between the network device and the terminal device.

The MCS mapping relationship includes at least one of: a first mapping relationship or a second mapping relationship. The first mapping relationship includes MCS information corresponding to a scenario where the transmission parameter information indicates that the number of transmission layers of the channel is 1. The second mapping relationship includes MCS information corresponding to a scenario where the transmission parameter information indicates that the number of transmission layers of the channel is greater than or equal to 2. The first mapping relationship is different from the second mapping relationship.

In some embodiments, the MCS mapping relationship is specified by a communication protocol or configured by the network device.

In some embodiments, the first mapping relationship includes at least two types of mapping relationships.

In some embodiments, the second mapping relationship includes at least two types of mapping relationships; or the second mapping relationship includes at least four types of mapping relationships.

In some embodiments, the MCS mapping relationship includes one or more of information elements such as an MCS index, a target code rate, a modulation order, and a spectral efficiency. In some embodiments, the MCS index has a mapping relationship with the target code rate, a mapping relationship with the modulation order, and a mapping relationship with the spectral efficiency. In some embodiments, the mapping relationship between the MCS index and the target code rate, the mapping relationship between the MCS index and the modulation order, and the mapping relationship between the MCS index and the spectral efficiency are stored in the form of an MCS mapping table.

The MCS information refers to the MCS information used during channel transmission, including one or more of information elements such as the modulation order, the target code rate, and the spectral efficiency.

It should be understood that in the present disclosure, “transmission” may refer to either sending or receiving, or include both sending and receiving operations.

In view of the above, the method according to the embodiments of the present disclosure supports determining different MCS information for channels with different numbers of transmission layers by transmitting transmission parameter information. Compared with a design in the related art where the same MCS mapping table is used regardless of the number of transmission layers of the channel, the method according to the embodiments of the present disclosure supports determining more accurate and appropriate MCS information for channels with different numbers of transmission layers. This improves demodulation performance of the channel, enhances coverage and transmission quality of the channel, and improves communication efficiency of a communication system.

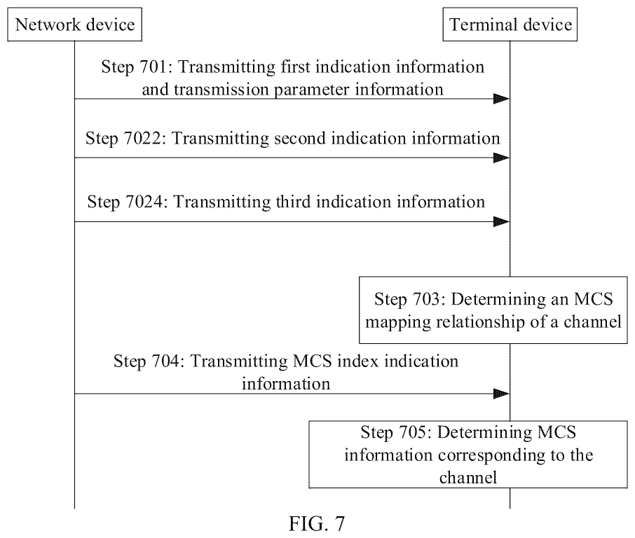

FIG. 7 illustrates a schematic flowchart of a method for determining MCS mapping information according to some exemplary embodiments of the present disclosure. Illustrative description is given by using an example where the method is performed by a terminal device and a network device. The method includes at least some of the following steps.

In step 701, the network device transmits first indication information and transmission parameter information to the terminal device.

The transmission parameter information is transmission parameter information directed to a channel and is used to indicate transmission parameters of the channel. The transmission parameters include one or more of: the number of transmission layers, a coding parameter, a modulation parameter, or other parameters. In some embodiments, the number of transmission layers of the channel is explicitly or implicitly indicated by the transmission parameter information. In some embodiments, a specific manner of implicit indication may be specified by a communication protocol, configured by the network device, or determined via negotiation between the network device and the terminal device.

In some embodiments, the first indication information is used to indicate that transform precoding is enabled. In some embodiments, the first indication information is used to indicate that channel transmission adopts a DFT-s-OFDM waveform. In some embodiments, the first indication information is used to indicate switching from a CP-OFDM waveform to the DFT-s-OFDM waveform. In some embodiments, the first indication information is used to indicate that precoding is enabled for the channel transmission. In some embodiments, the first indication information is used to indicate that the channel transmission is performed via precoding, where an MCS mapping relationship includes a mapping relationship associated with the channel transmission via precoding.

In some embodiments, the first indication information is carried by RRC signaling, a MAC CE, or DCI.

In some embodiments, the first indication information is configured in: a parameter msg3-transformPrecoder, a parameter msgA-TransformPrecoder, a parameter transformPrecoder in a parameter pusch-Config, or a parameter transformPrecoder in a parameter configuredGrantConfig.

In the embodiments of the present disclosure, illustrative description is given hereinafter by using an example where the channel is a PUSCH.

In some embodiments, the transmission parameter information includes a precoding information and number of layers indicator (i.e., a transmitted precoding matrix indicator (TPMI)). Exemplarily, in a case where PUSCH transmission is codebook-based PUSCH transmission, the transmission parameter information includes the TPMI.

In some embodiments, the transmission parameter information includes a sounding reference signal resource indicator (SRI). Exemplarily, in a case where the PUSCH transmission is non-codebook-based PUSCH transmission, the transmission parameter information includes the SRI.

In some embodiments, the first indication information is an RRC parameter msg3-transformPrecoder for one or more of: a PUSCH scheduled by RAR UL grant, a PUSCH scheduled by fallbackRAR UL grant, or a PUSCH scrambled by a TC-RNTI and scheduled by DCI in DCI format 0_0.

In some embodiments, the first indication information is an RRC parameter msgA-TransformPrecoder or msg3-transformPrecoder for an MsgA PUSCH.

In some embodiments, in a case where the PUSCH is scheduled by DCI in DCI format 0_0, and the PUSCH is scrambled by one of: a CS-RNTI with NDI=1, a C-RNTI, an MCS-C-RNTI, or an SP-CSI-RNTI, the first indication information is msg3-transformPrecoder.

In some embodiments, in a case where the PUSCH is scheduled by DCI in a DCI format other than DCI format 0_0, the first indication information is transformPrecoder in an RRC parameter pusch-Config.

In some embodiments, the first indication information is transformPrecoder in an RRC parameter configuredGrantConfig for a configured grant PUSCH.

In step 7022, the network device transmits second indication information to the terminal device.

The second indication information is used to indicate a first QAM scheme. In some embodiments, the first QAM scheme includes one or more of: a QAM64 scheme, a non-QAM256 scheme, or a non-QAM64LowSE scheme.

In some embodiments, the second indication information is used to indicate the QAM64 scheme; or the second indication information is not used to indicate a QAM256 scheme or a QAM64LowSE scheme.

In some embodiments, the second indication information includes a parameter configured as ‘QAM64,’ or excludes a parameter configured as ‘QAM256,’ or excludes a parameter configured as ‘QAM64LowSE.’

In some embodiments, the second indication information is carried in RRC signaling or a MAC CE. Alternatively, it may be understood that the second indication information is RRC signaling or MAC CE signaling.

In step 7024, the network device transmits third indication information to the terminal device.

The third indication information is used to indicate a second QAM scheme. In some embodiments, the second QAM scheme includes a QAM64LowSE scheme.

In some embodiments, the third indication information is used to indicate the QAM64LowSE scheme.

In some embodiments, the third indication information includes a parameter configured as ‘QAM64LowSE.’

In some embodiments, the third indication information is carried in RRC signaling or a MAC CE. Alternatively, it may be understood that the third indication information is RRC signaling or MAC CE signaling.

In some embodiments, the second indication information and the third indication information may correspond to the same type of RRC signaling or the same RRC signaling, that is, the second indication information and the third indication information are carried in the same RRC signaling for transmission, but contents indicated by the second indication information and the third indication information are different. Similarly, the second indication information and the third indication information may correspond to the same MAC CE, that is, the second indication information and the third indication information are carried in the same MAC CE for transmission, but the contents indicated by the second indication information and the third indication information are different.

Exemplarily, first RRC signaling may be used to carry the second indication information and also be used to carry the third indication information. In a case where a format of the first RRC signaling is a first format, the first RRC signaling carries the second indication information; and in a case where the format of the first RRC signaling is a second format, the first RRC signaling carries the third indication information. Alternatively, in a case where a value of the first RRC signaling is a third value, the first RRC signaling carries the second indication information; and in a case where the value of the first RRC signaling a fourth value, the first RRC signaling carries the third indication information.

In some embodiments, the second indication information and the third indication information may correspond to different RRC signaling, that is, the second indication information and the third indication information are carried in different RRC signaling for transmission, and the contents indicated by the second indication information and the third indication information are different.

Exemplarily, the second indication information is carried in first RRC signaling, while the third indication information is carried in second RRC signaling. The first RRC signaling and the second RRC signaling differ in one or more of the following aspects: name, format, parameters, message content, and transmission channel.

In step 703, the terminal device determines an MCS mapping relationship of a channel.

In a case where the transmission parameter information indicates that the number of transmission layers of the channel is 1, the MCS mapping relationship of the channel is determined as a first mapping relationship.

In some embodiments, the first mapping relationship includes one or more of information elements such as an MCS index, a target code rate, a modulation order, and a spectral efficiency. In some embodiments, the MCS index has a mapping relationship with the target code rate, a mapping relationship with the modulation order, and a mapping relationship with the spectral efficiency. In some embodiments, the first mapping relationship includes at least one of: a first MCS mapping relationship or a second MCS mapping relationship. In some embodiments, the first MCS mapping relationship is stored in the form of a first MCS mapping table. In some embodiments, the second MCS mapping relationship is stored in the form of a second MCS mapping table.

In some embodiments, the first MCS mapping table and the second MCS mapping table may be merged into a single MCS mapping table; or the first MCS mapping table and the second MCS mapping table may be split into more MCS mapping tables.

Exemplarily, the first MCS mapping table is as listed in Table 1, and the second MCS mapping table is as listed in Table 2.

TABLE 1
First MCS Mapping Table

| MCS Index | Modulation | Target Code Rate | Spectral |
|---|---|---|---|
| (I_{MCS}) | Order (Qₘ) | (R × [1024]) | Efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | Reserved |
| 29 | 2 | Reserved |
| 30 | 4 | Reserved |
| 31 | 6 | Reserved |

TABLE 2
Second MCS Mapping Table

| MCS Index | Modulation | Target Code Rate | Spectral |
|---|---|---|---|
| (I_{MCS}) | Order (Qₘ) | (R × [1024]) | Efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 4 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 4 | 658 | 2.5703 |
| 22 | 4 | 699 | 2.7305 |
| 23 | 4 | 772 | 3.0156 |
| 24 | 6 | 567 | 3.3223 |
| 25 | 6 | 616 | 3.6094 |
| 26 | 6 | 666 | 3.9023 |
| 27 | 6 | 772 | 4.5234 |

| | | |
|---|---|---|
| 28 | q | Reserved |
| 29 | 2 | Reserved |
| 30 | 4 | Reserved |
| 31 | 6 | Reserved |

In a case where the number of transmission layers is 1, the specific method for determining the MCS mapping table of the channel may refer to the above description, which is not elaborated herein.

In a case where the transmission parameter information indicates that the number of transmission layers of the channel is greater than or equal to 2, the MCS mapping relationship of the channel is determined as the second mapping relationship.

In some embodiments, the second mapping relationship includes one or more of information elements such as an MCS index, a target code rate, a modulation order, and a spectral efficiency. In some embodiments, the MCS index has a mapping relationship with the target code rate, a mapping relationship with the modulation order, and a mapping relationship with the spectral efficiency. In some embodiments, the second mapping relationship includes at least one of: a third MCS mapping relationship or a fourth MCS mapping relationship. In some embodiments, the third MCS mapping relationship is stored in the form of a third MCS mapping table. In some embodiments, the fourth MCS mapping relationship is stored in the form of a fourth MCS mapping table.

In some embodiments, the third MCS mapping table and the fourth MCS mapping table may be merged into a single MCS mapping table; or the third MCS mapping table and the fourth MCS mapping table may be split into more MCS mapping tables.

Exemplarily, the third MCS mapping table is as listed in Table 3, and the fourth MCS mapping table is as listed in Table 4.

TABLE 3
Third MCS Mapping Table

| MCS Index | Modulation | Target Code Rate | Spectral |
|---|---|---|---|
| (I_{MCS}) | Order (Qₘ) | (R × [1024]) | Efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | Reserved |
| 30 | 4 | Reserved |
| 31 | 6 | Reserved |

TABLE 4
Fourth MCS Mapping Table

| MCS Index | Modulation | Target Code Rate | Spectral |
|---|---|---|---|
| (I_{MCS}) | Order (Qₘ) | (R × [1024]) | Efficiency |
| 0 | 2 | 30 | 0.0586 |
| 1 | 2 | 40 | 0.0781 |
| 2 | 2 | 50 | 0.0977 |
| 3 | 2 | 64 | 0.1250 |
| 4 | 2 | 78 | 0.1523 |
| 5 | 2 | 99 | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 4 | 340 | 1.3281 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 6 | 438 | 2.5664 |
| 22 | 6 | 466 | 2.7305 |
| 23 | 6 | 517 | 3.0293 |
| 24 | 6 | 567 | 3.3223 |
| 25 | 6 | 616 | 3.6094 |
| 26 | 6 | 666 | 3.9023 |
| 27 | 6 | 719 | 4.2129 |
| 28 | 6 | 772 | 4.5234 |

| | | |
|---|---|---|
| 29 | 2 | Reserved |
| 30 | 4 | Reserved |
| 31 | 6 | Reserved |

In some embodiments, the first MCS mapping table, the second MCS mapping table, the third MCS mapping table, and the fourth MCS mapping table may be merged into a single MCS mapping table; or the first MCS mapping table, the second MCS mapping table, the third MCS mapping table, and the fourth MCS mapping table may be split into more MCS mapping tables.

In some embodiments, in a case where the terminal device receives the first indication information and the number of PUSCH transmission layers is greater than or equal to 2, the terminal device determines the MCS mapping relationship of the PUSCH as the third MCS mapping relationship based on the first indication information and the transmission parameter information. This determination method may be regarded as a default approach. The default approach may be determined via negotiation between the network device and the terminal device, specified by a communication protocol, or configured by the network device. That is, in a case where a waveform of the channel is a DFT-s-OFDM waveform and the number of transmission layers of the channel is greater than or equal to 2, the MCS mapping relationship of the channel is determined as the third MCS mapping relationship by default.

In some embodiments, in a case where the terminal device receives the first indication information and the number of PUSCH transmission layers is greater than or equal to 2, the terminal device determines the MCS mapping relationship of the PUSCH as the second mapping relationship based on the first indication information and the transmission parameter information, that is, the MCS mapping relationship of the PUSCH is the third MCS mapping relationship or the fourth MCS mapping relationship. Further, in a case where the terminal device also receives the second indication information, the terminal device determines the MCS mapping relationship of the PUSCH as the third MCS mapping relationship based on the second indication information, the first indication information, and the transmission parameter information.

By comparing the third MCS mapping table with the first MCS mapping table, for an MCS index of 17, a modulation order corresponding to the third MCS mapping table is 6, a target code rate corresponding to the third MCS mapping table is 438, and a spectral efficiency corresponding to the third MCS mapping table is 2.5664. Compared with a modulation order, a target code rate, and a spectral efficiency corresponding to an MCS index of 16 in the first MCS mapping table, the third MCS mapping table achieves the spectral efficiency similar to that of the first MCS mapping table at a lower code rate, thereby effectively improving the demodulation performance of the PUSCH and enhancing the coverage of the PUSCH.

In some embodiments, in a case where the terminal device receives the first indication information and the number of PUSCH transmission layers is greater than or equal to 2, the terminal device determines the MCS mapping relationship of the PUSCH as the fourth MCS mapping relationship based on the first indication information and the transmission parameter information. This determination method may be regarded as a default approach. The default approach may be determined via negotiation between the network device and the terminal device, specified by a communication protocol, or configured by the network device. That is, in a case where a waveform of the channel is a DFT-s-OFDM waveform and the number of transmission layers of the channel is greater than or equal to 2, the MCS mapping relationship of the channel is determined as the fourth MCS mapping relationship by default.

In some embodiments, in a case where the terminal device receives the first indication information and the number of PUSCH transmission layers is greater than or equal to 2, the terminal device determines the MCS mapping relationship of the PUSCH as the second mapping relationship based on the first indication information and the transmission parameter information, that is, the MCS mapping relationship of the PUSCH is the third MCS mapping relationship or the fourth MCS mapping relationship. Further, in a case where the terminal device also receives the third indication information, the terminal device determines the MCS mapping relationship of the PUSCH as the fourth MCS mapping relationship based on the third indication information, the first indication information, and the transmission parameter information.

By comparing the fourth MCS mapping table with the second MCS mapping table, for an MCS index of 21, 22, or 23, a modulation order, a target code rate, and a spectral efficiency corresponding to the fourth MCS mapping table, in comparison with those in the second MCS mapping table, demonstrate that the fourth MCS mapping table achieves the spectral efficiency similar to that of the second MCS mapping table at a lower code rate, thereby effectively improving the demodulation performance of the PUSCH and enhancing the coverage of the PUSCH.

In step 704, the network device transmits MCS index indication information to the terminal device.

The MCS index indication information is used to determine an MCS index corresponding to the channel. The MCS index corresponding to the channel refers to an MCS index of the channel in the MCS mapping relationship.

In some embodiments, the terminal device determines, based on the MCS index indication information, a target row, a target column, or a target element corresponding to the channel in the MCS mapping relationship. Herein, the element may be understood as an entry or a table cell.

In some embodiments, the MCS index indication information is carried in DCI.

Exemplarily, the MCS index indication information occupies 5 bits and is carried in DCI. For example, the MCS index indication information indicates that the MCS index corresponding to the channel is 1.

In step 705, the terminal device determines MCS information corresponding to the channel.

The MCS information includes one or more of: a modulation order, a target code rate, or a spectral efficiency.

In some embodiments, the MCS mapping table includes the MCS index, and also includes one or more of: the modulation order, the target code rate, or the spectral efficiency. Based on an MCS index, one or more of a modulation order, a target code rate, and a spectral efficiency corresponding to the MCS index may be determined in the MCS mapping relationship.

Exemplarily, in a case where the terminal device determines in step 703 that the MCS mapping relationship of the PUSCH is the third MCS mapping table, and the terminal device receives the MCS indication information indicating the MCS index is 1, the terminal device uses the modulation order, target code rate, and spectral efficiency corresponding to the MCS index of 1 in the third MCS mapping table to encode and modulate the PUSCH, or to demodulate and decode the PUSCH.

It should be understood that in the embodiments of the present disclosure, step 7022 and step 7024 are optional. For example, neither step 7022 nor step 7024 is performed; or step 7022 is performed but step 7024 is not performed; or step 7024 is performed but step 7022 is not performed. The execution order of the above steps may be adjusted according to actual conditions. For example, step 7022 is performed prior to step 701; or step 7024 is performed prior to step 701; or step 704 is performed prior to step 703; or step 704 is performed prior to step 701; or step 704 is performed prior to step 7022; or step 704 is performed prior to step 7024, and so on. The above steps may be split or merged according to actual conditions. For example, step 701 is split into two steps, and one is the network device transmitting the first indication information to the terminal device, and the other is the network device transmitting the transmission parameter information to the terminal device; or any two of step 701, step 7022, and step 704 are merged into a single step; or any two of step 701, step 7024, and step 704 are merged into a single step; or step 701, step 7022, and step 704 are merged into a single step; or step 701, step 7024, and step 704 are merged into a single step; or step 703 and step 705 are merged into a single step, and so on.

In view of the above, in the method according to the embodiments of the present disclosure, in a case where the terminal device receives the first indication information and the number of transmission layers of the channel is greater than or equal to 2, the terminal device may determine the MCS mapping relationship in a default manner, or further determine the MCS mapping relationship based on the second indication information or the third indication information. Therefore, the method according to the embodiments of the present disclosure achieves high flexibility and meets the requirements for determining MCS mapping information in different scenarios. The scheme of determining the MCS mapping relationship in a default manner is simple and convenient, which effectively improves communication efficiency. The scheme of further determining the MCS mapping relationship based on the second indication information or the third indication information has higher accuracy, and enables determination of a more appropriate and better-matched MCS mapping relationship for the channel according to actual conditions, thus effectively improving communication quality.

Moreover, compared with a scheme where the same MCS mapping table is configured for channels with different transmission layers without considering the number of transmission layers, the scheme according to the embodiments of the present disclosure is more targeted, and thus, the determined MCS mapping relationship is more matched with the transmission parameters of the channel, which significantly improves the transmission efficiency and transmission quality of a communication system. The third MCS mapping relationship and the fourth MCS mapping relationship, compared with the first MCS mapping relationship and the second MCS mapping relationship, support achieving a similar spectral efficiency at a lower code rate. This contributes to improve the demodulation performance of the channel and enhance the coverage of the channel.

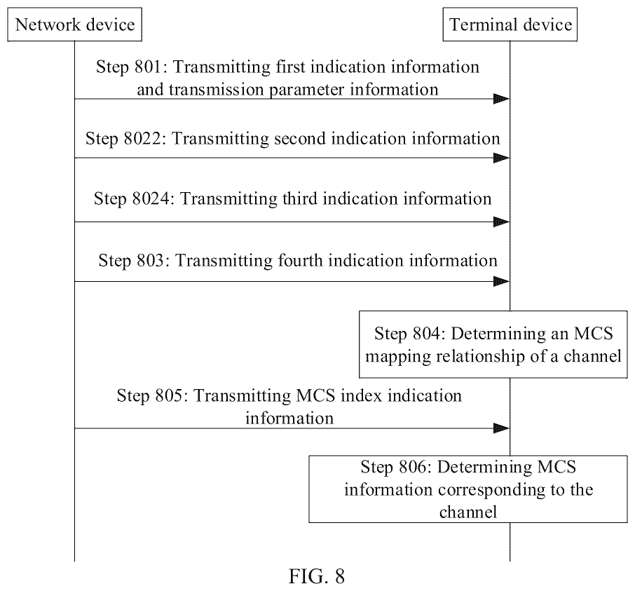

FIG. 8 illustrates a schematic flowchart of a method for determining MCS mapping information according to some exemplary embodiments of the present disclosure. Illustrative description is given by using an example where the method is performed by a terminal device and a network device. The method includes at least some of the following steps.

In step 801, the network device transmits first indication information and transmission parameter information to the terminal device.

For related contents, reference may be made to step 701, which are not elaborated herein.

In step 8022, the network device transmits second indication information to the terminal device.

The second indication information is used to indicate a first QAM scheme. In some embodiments, the first QAM scheme includes one or more of: a QAM64 scheme, a non-QAM256 scheme, or a non-QAM64LowSE scheme.

In some embodiments, the second indication information is used to indicate a QAM64 scheme; or not used to indicate a QAM256 scheme, or a QAM64LowSE scheme.

In some embodiments, the second indication information includes a parameter configured as ‘QAM64,’ or excludes a parameter configured as ‘QAM256,’ or excludes a parameter configured as ‘QAM64LowSE.’

In some embodiments, the second indication information is carried in RRC signaling or a MAC CE. Alternatively, it may be understood that the second indication information is RRC signaling or MAC CE signaling.

In step 8024, the network device transmits third indication information to the terminal device.

The third indication information is used to indicate a second QAM scheme. In some embodiments, the second QAM scheme includes a QAM64LowSE scheme.

In some embodiments, the third indication information is used to indicate the QAM64LowSE scheme.

In some embodiments, the third indication information includes a parameter configured as ‘QAM64LowSE.’

In some embodiments, the third indication information is carried in RRC signaling or a MAC CE. Alternatively, it may be understood that the third indication information is RRC signaling or MAC CE signaling.

In some embodiments, the second indication information and the third indication information may correspond to the same type of RRC signaling or the same RRC signaling, that is, the second indication information and the third indication information are carried in the same RRC signaling for transmission, but contents indicated by the second indication information and the third indication information are different.

Exemplarily, first RRC signaling may be used to carry the second indication information and also be used to carry the third indication information. In a case where a format of the first RRC signaling is a first format, the first RRC signaling carries the second indication information; in a case where the format of the first RRC signaling is a second format, the first RRC signaling carries the third indication information. Alternatively, in a case where a value of the first RRC signaling is a third value, the first RRC signaling carries the second indication information; and in a case where the value of the first RRC signaling is a fourth value, the first RRC signaling carries the third indication information.

In some embodiments, the second indication information and the third indication information may correspond to different RRC signaling, that is, the second indication information and the third indication information are carried in different RRC signaling for transmission, and the contents indicated by the second indication information and the third indication information are different.

Exemplarily, the second indication information is carried in first RRC signaling, while the third indication information is carried in second RRC signaling. The first RRC signaling and the second RRC signaling differ in one or more of the following aspects: name, format, parameters, message content, and transmission channel.

In step 803, the network device transmits fourth indication information to the terminal device.

In some embodiments, a value of the fourth indication information is used to indicate or determine the MCS mapping relationship.

In some embodiments, the fourth indication information is carried in RRC signaling, a MAC CE, or DCI.

In step 804, the terminal device determines an MCS mapping relationship of a channel.

In a case where the transmission parameter information indicates that the number of transmission layers of the channel is 1, the MCS mapping relationship of the channel is determined as a first mapping relationship.

In some embodiments, the first mapping relationship includes one or more of information elements such as an MCS index, a target code rate, a modulation order, and a spectral efficiency. In some embodiments, the MCS index has a mapping relationship with the target code rate, a mapping relationship with the modulation order, and a mapping relationship with the spectral efficiency. In some embodiments, the first mapping relationship includes at least one of: a first MCS mapping relationship or a second MCS mapping relationship. In some embodiments, the first MCS mapping relationship is stored in the form of a first MCS mapping table. In some embodiments, the second MCS mapping relationship is stored in the form of a second MCS mapping table.

In some embodiments, the first MCS mapping table and the second MCS mapping table may be merged into a single MCS mapping table; or the first MCS mapping table and the second MCS mapping table may be split into more MCS mapping tables.

Exemplarily, the first MCS mapping table is as listed in Table 1, and the second MCS mapping table is as listed in Table 2.

In a case where the number of transmission layers is 1, the specific method for determining the MCS mapping table of the channel may refer to the above description, which is not elaborated herein.

In a case where the transmission parameter information indicates that the number of transmission layers of the channel is greater than or equal to 2, the MCS mapping relationship of the channel is determined as the second mapping relationship.

In some embodiments, the second mapping relationship includes one or more of information elements such as an MCS index, a target code rate, a modulation order, and a spectral efficiency. In some embodiments, the MCS index has a mapping relationship with the target code rate, a mapping relationship with the modulation order, and a mapping relationship with the spectral efficiency. In some embodiments, the second mapping relationship includes at least one of: the first MCS mapping relationship, the second MCS mapping relationship, a third MCS mapping relationship, or a fourth MCS mapping relationship. In some embodiments, the first MCS mapping relationship is stored in the form of the first MCS mapping table. In some embodiments, the second MCS mapping relationship is stored in the form of the second MCS mapping table. In some embodiments, the third MCS mapping relationship is stored in the form of a third MCS mapping table. In some embodiments, the fourth MCS mapping relationship is stored in the form of a fourth MCS mapping table.

Exemplarily, the third MCS mapping table is as listed in Table 3, and the fourth MCS mapping table is as listed in Table 4.

In some embodiments, in a case where the terminal device receives the first indication information and the number of PUSCH transmission layers is greater than or equal to 2, the terminal device determines the MCS mapping relationship of the PUSCH as the second mapping relationship based on the first indication information and the transmission parameter information, that is, the MCS mapping relationship of the PUSCH is the first MCS mapping relationship, the second MCS mapping relationship, the third MCS mapping relationship, or the fourth MCS mapping relationship. Further, in a case where the terminal device receives the second indication information, the terminal device determines the MCS mapping relationship of the PUSCH as the first MCS mapping relationship or the third MCS mapping relationship based on the second indication information, the first indication information, and the transmission parameter information. Further, in a case where a value of the fourth indication information received by the terminal device is a first value, the terminal device determines the MCS mapping relationship of the PUSCH as the first MCS mapping relationship based on the fourth indication information, the second indication information, the first indication information, and the transmission parameter information; or in a case where a value of the fourth indication information received by the terminal device is a second value, the terminal device determines the MCS mapping relationship of the PUSCH as the third MCS mapping relationship based on the fourth indication information, the second indication information, the first indication information, and the transmission parameter information.

Exemplarily, the fourth indication information occupies 1 bit and is carried in RRC signaling, a MAC CE, or DCI. In a case where the terminal device receives the second indication information and the fourth indication information, and a state value of the fourth indication information is 0, the terminal device determines the MCS mapping relationship of the channel as the third MCS mapping table; or in a case where the terminal device receives the second indication information and the fourth indication information, and a state value of the fourth indication information is 1, the terminal device determines the MCS mapping relationship of the channel as the first MCS mapping table.

By comparing the third MCS mapping table with the first MCS mapping table, for an MCS index of 17, a modulation order corresponding to the third MCS mapping table is 6, a target code rate corresponding to the third MCS mapping table is 438, and a spectral efficiency corresponding to the third MCS mapping table is 2.5664. Compared with a modulation order, a target code rate, and a spectral efficiency corresponding to an MCS index of 16 in the first MCS mapping table, the third MCS mapping table achieves the spectral efficiency similar to that of the first MCS mapping table at a lower code rate, thereby effectively improving the demodulation performance of the PUSCH and enhancing the coverage of the PUSCH.

In some embodiments, in a case where the terminal device receives the first indication information and the number of PUSCH transmission layers is greater than or equal to 2, the terminal device determines the MCS mapping relationship of the PUSCH as the second mapping relationship based on the first indication information and the transmission parameter information, that is, the MCS mapping relationship of the PUSCH is the first MCS mapping relationship, the second MCS mapping relationship, the third MCS mapping relationship, or the fourth MCS mapping relationship. Further, in a case where the terminal device receives the third indication information, the terminal device determines the MCS mapping relationship of the PUSCH as the second MCS mapping relationship or the fourth MCS mapping relationship based on the third indication information, the first indication information, and the transmission parameter information. Further, in a case where a value of the fourth indication information received by the terminal device is a first value, the terminal device determines the MCS mapping relationship of the PUSCH as the second MCS mapping relationship based on the fourth indication information, the third indication information, the first indication information, and the transmission parameter information; or in a case where a value of the fourth indication information received by the terminal device is a second value, the terminal device determines the MCS mapping relationship of the PUSCH as the fourth MCS mapping relationship based on the fourth indication information, the third indication information, the first indication information, and the transmission parameter information.

Exemplarily, the fourth indication information occupies 1 bit and is carried in RRC signaling, a MAC CE, or DCI; a waveform of the channel is a DFT-s-OFDM waveform; and the number of transmission layers of the channel is greater than or equal to 2. In a case where the terminal device receives the third indication information and the fourth indication information, and a state value of the fourth indication information is 0, the terminal device determines the MCS mapping relationship of the channel as the fourth MCS mapping table; or in a case where the terminal device receives the third indication information and the fourth indication information, and a state value of the fourth indication information is 1, the terminal device determines the MCS mapping relationship of the channel as the second MCS mapping table.

By comparing the fourth MCS mapping table with the second MCS mapping table, for an MCS index of 21, 22, or 23, a modulation order, a target code rate, and a spectral efficiency corresponding to the fourth MCS mapping table, in comparison with those in the second MCS mapping table, demonstrate that the fourth MCS mapping table achieves the spectral efficiency similar to that of the second MCS mapping table at a lower code rate, thereby effectively improving the demodulation performance of the PUSCH and enhancing the coverage of the PUSCH.

In step 805, the network device transmits MCS index indication information to the terminal device.

The MCS index indication information is used to determine an MCS index corresponding to the channel. The MCS index corresponding to the channel refers to an MCS index of the channel in the MCS mapping relationship determined based on the transmission parameter information.

Alternatively, the MCS index indication information is used to determine a target row, a target column, or a target element corresponding to the channel in the MCS mapping table. Herein, the element may be understood as an entry or a table cell.

In some embodiments, the MCS index indication information is carried in DCI.

Exemplarily, the MCS index indication information occupies 5 bits and is carried in DCI, and the MCS indication information indicates that the MCS index corresponding to the channel is 17.

In step 806, the terminal device determines MCS information corresponding to the channel.

The MCS information includes one or more of: a modulation order, a target code rate, or a spectral efficiency.

In some embodiments, the MCS mapping table includes the MCS index, and also includes one or more of: the modulation order, the target code rate, or the spectral efficiency. Based on an MCS index, one or more of a modulation order, a target code rate, and a spectral efficiency corresponding to the MCS index may be determined in the MCS mapping relationship.

Exemplarily, in a case where the terminal device determines in step 804 that the MCS mapping table of the PUSCH is the fourth MCS mapping table, and the terminal device receives the MCS indication information indicating the MCS index is 17, the terminal device uses the modulation order, target code rate, and spectral efficiency corresponding to the MCS index of 17 in the fourth MCS mapping table to encode and modulate the PUSCH, or to demodulate and decode the PUSCH.

It should be understood that in the embodiments of the present disclosure, step 8022 and step 8024 are optional. For example, neither step 8022 nor step 8024 is performed; or step 8022 is performed but step 8024 is not performed; or step 8024 is performed but step 8022 is not performed. The execution order of the above steps may be adjusted according to actual conditions. For example, step 8022 is executed prior to step 801; or step 8024 is performed prior to step 801; or step 803 is performed prior to step 801; or step 803 is performed prior to step 8022; or step 803 is performed prior to step 8024; or step 805 is performed prior to step 801; or step 805 is performed prior to step 8022; or step 805 is performed prior to step 8024; or step 805 is performed prior to step 803, and so on. The above steps may be split or merged according to actual conditions. For example, step 801 is split into two steps, and one is the network device transmitting the first indication information to the terminal device, and the other is the network device transmitting the transmission parameter information to the terminal device; or any two or three of step 801, step 8022, step 803, and step 805 are merged into a single step; or any two or three of step 801, step 8024, step 803, and step 805 are merged into a single step; or step 801, step 8022, step 803, and step 805 are merged into a single step; or step 801, step 8024, step 803, and step 805 are merged into a single step; or step 804 and step 806 are merged into a single step, and so on.

In view of the above, the method according to the embodiments of the present disclosure provides a plurality of options for determining the MCS mapping information in a case where the terminal device receives the first indication information and the number of transmission layers of the channel is greater than or equal to 2. In addition, the terminal device may determine an MCS mapping relationship from a plurality of MCS mapping relationships based on the fourth indication information, the second indication information, or the third indication information. This not only enables the method according to the embodiments of the present disclosure to be suitable for determining MCS mapping relationships in various communication scenarios, but also supports determining a more appropriate, better-matched, and more accurate MCS mapping relationship for the channel based on actual conditions, thus effectively enhancing the flexibility in determining the MCS mapping relationship and improving the communication quality.

Moreover, compared with a scheme where the same MCS mapping table is configured for channels with different transmission layers without considering the number of transmission layers, the scheme according to the embodiments of the present disclosure is more targeted, and thus, the determined MCS mapping relationship is more matched with the transmission parameters of the channel, which significantly improves the transmission efficiency and transmission quality of a communication system. The third MCS mapping relationship and the fourth MCS mapping relationship, compared with the first MCS mapping relationship and the second MCS mapping relationship, support achieving similar spectral efficiency at a lower code rate. This contributes to improve the demodulation performance of the channel and enhance the coverage of the channel.

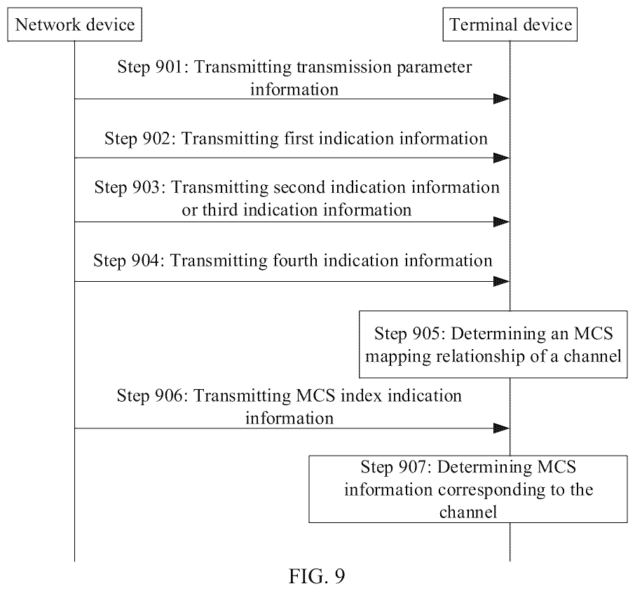

FIG. 9 illustrates a schematic flowchart of a method for determining MCS mapping information according to some exemplary embodiments of the present disclosure. Illustrative description is given by using an example where the method is performed by a terminal device and a network device. The method includes at least some of the following steps.

In step 901, the network device transmits transmission parameter information to the terminal device.

For related contents, reference may be made to step 610, which is not elaborated herein.

In step 902, the network device transmits first indication information to the terminal device.

For related contents, reference may be made to step 701 or step 801, which is not elaborated herein.

It should be understood that step 902 is optional.

That is, the channel transmission may or may not adopt the DFT-s-OFDM waveform, which may be understood that: the network device may not indicate to the terminal device to enable transform precoding; or the network device may indicate to the terminal device to disable transform precoding; or the network device may not indicate to the terminal device that the channel transmission adopts the DFT-s-OFDM waveform; or the network device may not indicate to the terminal device to switch from the CP-OFDM waveform to the DFT-s-OFDM waveform; or the network device may indicate to the terminal device that the channel transmission adopts the CP-OFDM waveform; or the network device may indicate to the terminal device to switch from the DFT-s-OFDM waveform to the CP-OFDM waveform; or the network device may indicate to the terminal device that the channel transmission adopts a waveform other than the CP-OFDM waveform and the DFT-s-OFDM waveform.

In step 903, the network device transmits second indication information or third indication information to the terminal device.

For related contents, reference may be made to step 7022, step 7024, step 8022, or step 8024, which is not elaborated herein.

It should be understood that step 903 is optional.

In step 904, the network device transmits fourth indication information to the terminal device.

For related contents, reference may be made to step 803, which is not elaborated herein.

It should be understood that step 904 is optional.

In step 905, the terminal device determines an MCS mapping relationship of a channel.

The method according to the embodiments of the present disclosure is applicable not only to the DFT-s-OFDM waveform but also to waveforms other than the DFT-s-OFDM waveform, such as the CP-OFDM waveform.

The method provided by the embodiments of the present disclosure is applicable not only to a single transmission reception point (TRP) scenario but also to a multi-TRP scenario.

In a case where the method according to the embodiments of the present disclosure is applied to the single-TRP scenario or the number of channels is one, the MCS mapping relationship may be determined with reference to the relevant contents in step 703 and step 804, which is not elaborated herein.

In a case where the method according to the embodiments of the present disclosure is applied to the multi-TRP scenario or the number of channels is greater than or equal to two, MCS mapping relationships may be determined for the channels, respectively. The MCS mapping relationships of different channels may be determined uniformly or separately. The MCS mapping relationships of different channels may be the same or different. For the method for determining the MCS mapping relationship of each channel, reference may be made to the relevant contents in step 703 and step 804, which is not elaborated herein.

Exemplarily, the method according to the embodiments of the present disclosure is applied to the multi-TRP scenario and a transmission scheme of the channel includes an SDM scheme or an SFN scheme, and the channel includes at least two channels, such as a first PUSCH and a second PUSCH, wherein the first PUSCH includes at least one PUSCH associated with first spatial information, and the second PUSCH includes at least one PUSCH associated with second spatial information. In this case, the terminal device may determine corresponding MCS mapping relationships for the first PUSCH and the second PUSCH, respectively. That is, the method according to the embodiments of the present disclosure supports the determination of appropriate MCS mapping relationships for channels in a more detailed and accurate manner by leveraging the spatial information of the channels, and fully considers various transmission parameters of the channels, thereby further enhancing the transmission quality and communication efficiency of the channels.

In step 906, the network device transmits MCS index indication information to the terminal device.

For related contents, reference may be made to step 704 and step 805, which are not elaborated herein.

In step 907, the terminal device determines MCS information corresponding to the channel.

The MCS information includes one or more of: a modulation order, a target code rate, or a spectral efficiency.

Upon receiving the MCS index indication information, the terminal device may determine an MCS index based on the MCS index indication information. Based on the determined MCS index, the terminal device may determine one or more of the modulation order, target code rate, and spectral efficiency corresponding to the channel in the determined MCS mapping table.

In a case where the method according to the embodiments of the present disclosure is applied to a single-TRP scenario or the number of channels is one, one or more of the modulation order, target code rate, and spectral efficiency may be determined with reference to relevant contents in step 705 and step 806, which is not elaborated herein.

In a case where the method according to the embodiments of the present disclosure is applied to a multi-TRP scenario or the number of channels is greater than or equal to two, MCS indexes may be determined for the channels, respectively. The MCS indexes of different channels may be determined uniformly or separately. The MCS indexes of different channels may be the same or different. For the method for determining the MCS index of each channel, reference may be made to relevant contents in step 705 and step 806, which is not elaborated herein.

In some embodiments, different channels may share the same MCS mapping relationship and the same MCS index; or different channels may share the same MCS mapping relationship but have different MCS indexes; or different channels may have different MCS mapping relationships but share the same MCS index; or different channels may have different MCS mapping relationships and different MCS indexes. Thus, the method according to the embodiments of the present disclosure offers significant flexibility by providing a plurality of candidate approaches for determining MCS mapping relationships and MCS indexes for channels, and meets the requirements for determining the MCS mapping relationships and MCS indexes in various communication scenarios.

In some embodiments, the determination of the MCS mapping information and MCS indexes for different channels may adopt a default approach. For example, by default, different channels may share the same MCS mapping relationship and correspond to a specific MCS mapping relationship, and/or by default, different channels may have identical MCS indexes, and all the MCS indexes are set to a specific MCS index. This approach ensures a high degree of simplicity in determining MCS mapping relationships and MCS indexes, significantly reducing resource consumption during the determination process of the MCS mapping relationship and the MCS indexes, and effectively enhancing transmission efficiency and demodulation efficiency.

In some embodiments, the determination of the MCS mapping information and MCS indexes for different channels may be carried out in different ways. This approach not only ensures a high degree of flexibility in determining MCS mapping relationships and MCS indices, but also enables each channel to be assigned a more appropriate MCS mapping relationship and MCS index, thereby effectively enhancing the transmission performance and demodulation performance of each channel. That is, the method according to the embodiments of the present disclosure supports the determination of appropriate MCS mapping relationships/MCS indexes for channels in a more detailed and accurate manner by leveraging the spatial information of the channels, fully considers various transmission parameters of the channel, and further improves the transmission quality and communication efficiency of the channel.

Exemplarily, the method according to the embodiments of the present disclosure is applicable to a multi-TRP scenario, a transmission scheme of the channel includes an SDM scheme or an SFN scheme, and the channel includes a first PUSCH and a second PUSCH, wherein the first PUSCH is associated with first spatial information, and the second PUSCH is associated with second spatial information. In this case, the terminal device may determine corresponding MCS indexes for the first PUSCH and the second PUSCH, respectively.

In a case where the MCS index corresponding to the first PUSCH and the MCS index corresponding to the second PUSCH are determined separately, or the MCS index corresponding to the first PUSCH is different from the MCS index corresponding to the second PUSCH, the determination methods of the MCS index corresponding to the first PUSCH and the MCS index corresponding to the second PUSCH include at least the following two types.

Type 1: The MCS indexes corresponding to the first PUSCH and the second PUSCH are respectively determined based on different MCS indication information.

For example, the terminal device determines the MCS index of the first PUSCH in the MCS mapping relationship based on first MCS indication information, and determines the index of the second PUSCH in the MCS mapping relationship based on second MCS indication information.

Exemplarily, the first MCS indication information and the second MCS indication information each occupy 5 bits, and the second MCS indication information is a new field in DCI.

Type 2: The MCS indexes corresponding to the first PUSCH and the second PUSCH are determined based on the same MCS indication information.

In an example, the terminal device determines the MCS index of the first PUSCH in the MCS mapping relationship based on the first MCS indication information, and determines the index of the second PUSCH in the MCS mapping relationship based on the first MCS indication information and a first offset value, wherein the first offset value is an integer.

In another example, the terminal device determines the MCS index of the first PUSCH in the MCS mapping relationship based on the first MCS indication information, and determines the index of the second PUSCH in the MCS mapping relationship based on the first MCS indication information and a first offset value.

In some embodiments, the first offset value is specified by a communication protocol, configured by the network device, or determined via negotiation between the network device and the terminal device.

In some embodiments, the first offset value is carried in DCI and occupies n bits, wherein n is a positive integer, such as 1, 2, 3, 4, or 5.

In some embodiments, the first offset value is a value in an offset value set. The offset value set is specified by a communication protocol, configured by the network device, or determined via negotiation between the network device and the terminal device.

Exemplarily, the first MCS indication information indicates that the MCS index is 17, then the terminal device determines that the MCS index of the first PUSCH in the MCS mapping relationship is 17. In a case where the offset value set is {−4, −2, 0, 2}, and the first offset value is indicated as −2, the terminal device determines that the MCS index of the second PUSCH in the MCS mapping relationship is 15 calculated as 17−2=15.

In a case where the MCS mapping relationship corresponding to the first PUSCH is assumed as the third MCS mapping table, the modulation order, target code rate, and spectral efficiency corresponding to the MCS index of 17 in the third MCS mapping table are used to encode, modulate, decode, or demodulate the first PUSCH. In a case where the MCS mapping relationship corresponding to the second PUSCH is also assumed as the third MCS mapping table, the modulation order, target code rate, and spectral efficiency corresponding to the MCS index of 15 in the third MCS mapping table are used to encode, modulate, decode, or demodulate the second PUSCH.

In view of the above, the method according to the embodiments of the present disclosure supports determining different MCS mapping relationships for channels in different communication scenarios, with different numbers of transmission layers, and different spatial information. Compared with a design in the related art where the same MCS mapping table is used regardless of the number of transmission layers of the channel, the method according to the embodiments of the present disclosure enables determination of a more accurate and appropriate MCS mapping relationship for channels with more than or equal to 2 transmission layers. This improves the demodulation performance of the channel, enhances the coverage and transmission quality of the channel, and increases the communication efficiency of the communication system.

In a case where different PUSCHs adopt the same MCS mapping relationship and/or MCS index, transmission resources are saved, the load of DCI used for scheduling the first PUSCH and the second PUSCH are reduced, the complexity of the overall determination process of the MCS mapping relationships and MCS indexes is reduced, the signaling consumption required for the overall determination process of the MCS mapping relationships and MCS indexes is saved, and the communication efficiency of the communication system is improved.

In a case where different PUSCHs adopt different MCS mapping relationships and/or MCS indexes, or adopt a separate determination method to determine the MCS mapping relationships and/or MCS indexes, the method according to the embodiments of the present disclosure becomes applicable to various communication scenarios, and supports matching more accurate and appropriate MCS mapping relationships and/or MCS indexes for channels under different channel conditions, thereby enabling channels with different transmission parameters to achieve better adaptability, transmission performance, and demodulation performance.

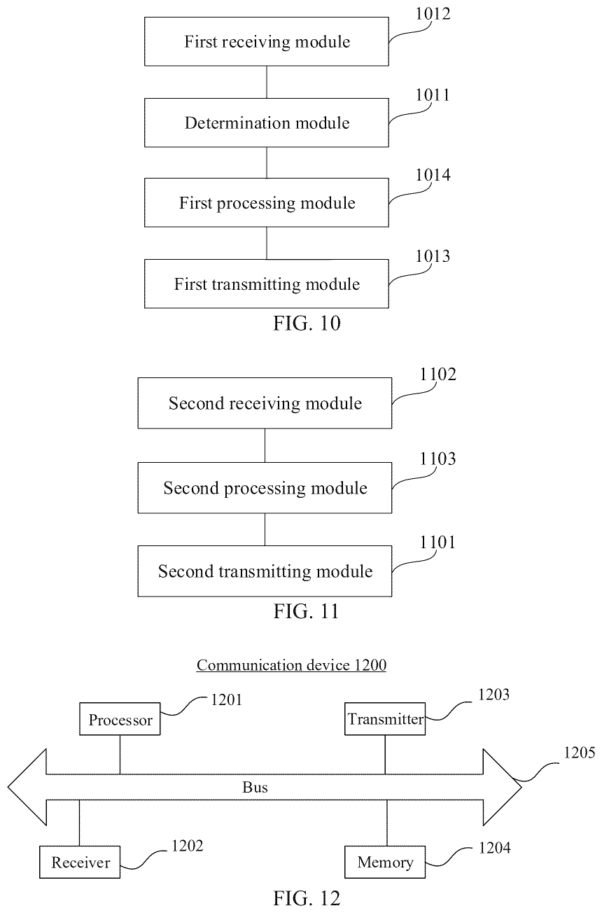

FIG. 10 illustrates a schematic structural diagram of an apparatus for determining MCS mapping information according to some exemplary embodiments of the present disclosure. The apparatus includes at least some of: a determination module 1011, a first receiving module 1012, a first transmitting module 1013, and a first processing module 1014.

The determination module 1011 is configured to determine MCS information of a channel based on transmission parameter information and an MCS mapping relationship.

The MCS mapping relationship includes at least one of: a first mapping relationship or a second mapping relationship. The first mapping relationship includes MCS information corresponding to a scenario where the transmission parameter information indicates that a number of transmission layers of the channel is 1. The second mapping relationship includes MCS information corresponding to a scenario where the transmission parameter information indicates that a number of transmission layers of the channel is greater than or equal to 2. The first mapping relationship is different from the second mapping relationship.

In some embodiments, the apparatus further includes a first receiving module 1012 configured to receive MCS mapping indication information, wherein the MCS mapping indication information is used to indicate the MCS mapping relationship.

In some embodiments, the determination module 1011 is further configured to determine the MCS information of the channel based on the transmission parameter information and the MCS mapping indication information.

In some embodiments, the first mapping relationship includes at least one of: a first MCS mapping relationship or a second MCS mapping relationship; and the second mapping relationship includes at least one of: the first MCS mapping relationship, the second MCS mapping relationship, a third MCS mapping relationship, or a fourth MCS mapping relationship; wherein the first MCS mapping relationship, the second MCS mapping relationship, the third MCS mapping relationship, and the fourth MCS mapping relationship are different from each other.

In some embodiments, the MCS mapping indication information includes first indication information, wherein the first indication information is used to indicate that channel transmission is performed via precoding, and the MCS mapping relationship includes a mapping relationship associated with the channel transmission via precoding.

In some embodiments, the determination module 1011 is further configured to: determine, in a case where the transmission parameter information indicates that the number of transmission layers of the channel is greater than or equal to 2, and the MCS mapping indication information includes the first indication information and second indication information, the MCS information of the channel based on the third MCS mapping relationship; or determine, in a case where the transmission parameter information indicates that the number of transmission layers of the channel is greater than or equal to 2, and the MCS mapping indication information includes the first indication information and third indication information, the MCS information of the channel based on the fourth MCS mapping relationship.

The second indication information is used to indicate a first QAM scheme, the third indication information is used to indicate a second QAM scheme, the first QAM scheme is different from the second QAM scheme, and the MCS mapping relationship includes at least one of: a mapping relationship associated with the first QAM scheme, or a mapping relationship associated with the second QAM scheme.

In some embodiments, the determination module 1011 is further configured to: determine, in a case where the transmission parameter information indicates that the number of transmission layers of the channel is greater than or equal to 2, and the MCS mapping indication information includes the first indication information, second indication information, and fourth indication information, the MCS information of the channel based on the first MCS mapping relationship or the third MCS mapping relationship; or determine, in a case where the transmission parameter information indicates that the number of transmission layers of the channel is greater than or equal to 2, and the MCS mapping indication information includes the first indication information, third indication information, and fourth indication information, the MCS information of the channel based on the second MCS mapping relationship or the fourth MCS mapping relationship.

The second indication information is used to indicate a first QAM scheme, the third indication information is used to indicate a second QAM scheme, the first QAM scheme is different from the second QAM scheme, and the MCS mapping relationship includes at least one of a mapping relationship associated with the first QAM scheme, or a mapping relationship associated with the second QAM scheme.

A value of the fourth indication information is used to indicate the MCS mapping relationship.

In some embodiments, the determination module 1011 is further configured to: determine, in a case where the transmission parameter information indicates that the number of transmission layers of the channel is greater than or equal to 2, the MCS mapping indication information includes the first indication information, the second indication information, and the fourth indication information, and the fourth indication information takes a first value, the MCS information of the channel based on the first MCS mapping relationship; determine, in a case where the transmission parameter information indicates that the number of transmission layers of the channel is greater than or equal to 2, the MCS mapping indication information includes the first indication information, the second indication information, and the fourth indication information, and the fourth indication information takes a second value, the MCS information of the channel based on the third MCS mapping relationship; determine, in a case where the transmission parameter information indicates that the number of transmission layers of the channel is greater than or equal to 2, the MCS mapping indication information includes the first indication information, the third indication information, and the fourth indication information, and the fourth indication information takes a first value, the MCS information of the channel based on the second MCS mapping relationship; or determine, in a case where the transmission parameter information indicates that the number of transmission layers of the channel is greater than or equal to 2, the MCS mapping indication information includes the first indication information, the third indication information, and the fourth indication information, and the fourth indication information takes a second value, the MCS information of the channel based on the fourth MCS mapping relationship.

In some embodiments, in the third MCS mapping relationship, a target code rate is 438 for an MCS index of 17.

In some embodiments, in the fourth MCS mapping relationship, a target code rate is 438 for an MCS index of 21; and/or a target code rate is 466 for an MCX index of 22; and/or a target code rate is 517 for an MCS index of 23.

In some embodiments, the fourth indication information is carried by RRC signaling, a MAC CE, or DCI.

In some embodiments, the second indication information and/or the third indication information is carried by RRC signaling.

In some embodiments, the second indication information and the third indication information are carried by the same RRC signaling, or the second indication information and the third indication information are carried by different RRC signaling.

In some embodiments, the first indication information is carried by at least one of: RRC signaling, a MAC CE, or DCI.

In some embodiments, the first indication information is configured in one of following parameters: msg3-transformPrecoder, msgA-TransformPrecoder, transformPrecoder in pusch-Config, or transformPrecoder in configuredGrantConfig.

In some embodiments, the determination module 1011 is further configured to determine an MCS index corresponding to the channel based on MCS index indication information, wherein the MCS index corresponding to the channel is an MCS index of the channel in the MCS mapping relationship.

In some embodiments, the determination module 1011 is further configured to determine the MCS information of the channel based on the transmission parameter information, the MCS mapping relationship, and the MCS index; wherein the MCS information includes at least one of: a modulation order, a target code rate, or a spectral efficiency.

In some embodiments, the MCS index indication information is carried by DCI.

In some embodiments, the channel includes one PUSCH or at least two PUSCHs.

In some embodiments, the at least two PUSCHs include a first PUSCH and a second PUSCH; wherein the first PUSCH includes at least one PUSCH associated with first spatial information, the second PUSCH includes at least one PUSCH associated with second spatial information, and the first spatial information is different from the second spatial information.

In some embodiments, an MCS mapping relationship corresponding to the first PUSCH is the same as or different from an MCS mapping relationship corresponding to the second PUSCH.

In some embodiments, an MCS index corresponding to the first PUSCH is the same as or different from an MCS index corresponding to the second PUSCH.

In some embodiments, the MCS index indication information includes first MCS index indication information and second MCS index indication information; and the MCS index corresponding to the first PUSCH is determined based on the first MCS index indication information, and the MCS index corresponding to the second PUSCH is determined based on the second MCS index indication information.

In some embodiments, the MCS index indication information includes first MCS index indication information; and the MCS index corresponding to the first PUSCH is determined based on the first MCS index indication information, and the MCS index corresponding to the second PUSCH is determined based on the first MCS index indication information and a first offset value.

In some embodiments, a value of the MCS index corresponding to the second PUSCH is a sum of the first offset value and a value of the MCS index corresponding to the first PUSCH.

In some embodiments, a transmission scheme of the channel includes an SDM scheme or an SFN scheme.

The determination module 1011 is configured to perform the steps related to determination, processing, and selection performed by the terminal device in the above embodiments.

In some embodiments, the apparatus further includes a first receiving module 1012, configured to perform the steps related to reception performed by the terminal device in the above embodiments.

In some embodiments, the apparatus further includes a first transmitting module 1013, configured to perform the steps related to transmission performed by the terminal device in the above embodiments.

In some embodiments, the apparatus includes one determination module 1011, configured to perform all the steps related to determination, processing, and selection performed by the terminal device in the above embodiments.

In some embodiments, the apparatus includes a plurality of determination modules 1011, respectively configured to perform part of the steps related to determination, processing, and selection performed by the terminal device in the above embodiments.

In some embodiments, the steps performed by different determination modules 1011 are completely the same, partially the same, or completely different.

In some embodiments, the apparatus includes one first receiving module 1012, configured to perform all the reception steps performed by the terminal device in the above embodiments.

In some embodiments, the apparatus includes a plurality of first receiving modules 1012, respectively configured to perform part of the reception steps performed by the terminal device in the above embodiments.

In some embodiments, the steps performed by different first receiving modules 1012 are completely the same, partially the same, or completely different.

In some embodiments, the apparatus includes one first transmitting module 1013, configured to perform all the transmission steps performed by the terminal device in the above embodiments.

In some embodiments, the apparatus includes a plurality of first transmitting modules 1013, respectively configured to perform part of the transmission steps performed by the terminal device in the above embodiments.

In some embodiments, the steps executed by different first transmitting modules 1013 are completely the same, partially the same, or completely different.

In some embodiments, the apparatus includes a first processing module 1014, configured to perform one or more operations of encoding, modulation, demodulation, and decoding on the channel based on the determined MCS information.

In view of the above, the apparatus according to the embodiments of the present disclosure supports determining different MCS information for channels with different numbers of transmission layers. Compared with a design in the related art where the same MCS mapping table is used regardless of the number of transmission layers of the channel, the apparatus according to the embodiments of the present disclosure supports determining more accurate and appropriate MCS information for channels with different numbers of transmission layers. This improves the demodulation performance of the channel, enhances the coverage and transmission quality of the channel, and improves the communication efficiency of a communication system.

FIG. 11 illustrates a schematic structural diagram of an apparatus for determining MCS mapping information according to some exemplary embodiments of the present disclosure. The apparatus includes at least some of: a second transmitting module 1101, a second receiving module 1102, and a second processing module 1103:

The second transmitting module 1101 is configured to transmit transmission parameter information, wherein the transmission parameter information is used with an MCS mapping relationship to determine MCS information of a channel.

The MCS mapping relationship includes at least one of: a first mapping relationship or a second mapping relationship. The first mapping relationship includes MCS information corresponding to a scenario where the transmission parameter information indicates that a number of transmission layers of the channel is 1. The second mapping relationship includes MCS information corresponding to a scenario where the transmission parameter information indicates that a number of transmission layers of the channel is greater than or equal to 2. The first mapping relationship is different from the second mapping relationship.

In some embodiments, the second transmitting module 1101 is further configured to transmit MCS mapping indication information, wherein the MCS mapping indication information is used to indicate the MCS mapping relationship.

In some embodiments, the first mapping relationship includes at least one of: a first MCS mapping relationship or a second MCS mapping relationship; and

the second mapping relationship includes at least one of: the first MCS mapping relationship, the second MCS mapping relationship, a third MCS mapping relationship, or a fourth MCS mapping relationship;

wherein the first MCS mapping relationship, the second MCS mapping relationship, the third MCS mapping relationship, and the fourth MCS mapping relationship are different from each other.

In some embodiments, the MCS mapping indication information includes first indication information, the first indication information is used to indicate that channel transmission is performed via precoding, and the MCS mapping relationship is a mapping relationship, from a plurality of MCS mapping relationships, associated with the channel transmission via precoding.

In some embodiments, in a case where the transmission parameter information indicates that the number of transmission layers of the channel is greater than or equal to 2, and the MCS mapping indication information includes the first indication information and second indication information, the MCS information of the channel is determined based on the third MCS mapping relationship; or in a case where the transmission parameter information indicates that the number of transmission layers of the channel is greater than or equal to 2, and the MCS mapping indication information includes the first indication information and third indication information, the MCS information of the channel is determined based on the fourth MCS mapping relationship.

The second indication information is used to indicate a first QAM scheme, the third indication information is used to indicate a second QAM scheme, the first QAM scheme is different from the second QAM scheme, and the MCS mapping relationship includes at least one of: a mapping relationship, from the plurality of MCS mapping relationships, associated with the first QAM scheme, or a mapping relationship, from the plurality of MCS mapping relationships, associated with the second QAM scheme.

In some embodiments, in a case where the transmission parameter information indicates that the number of transmission layers of the channel is greater than or equal to 2, and the MCS mapping indication information includes the first indication information, second indication information, and fourth indication information, the MCS information of the channel is determined based on the first MCS mapping relationship or the third MCS mapping relationship; or in a case where the transmission parameter information indicates that the number of transmission layers of the channel is greater than or equal to 2, and the MCS mapping indication information includes the first indication information, third indication information, and fourth indication information, the MCS information of the channel is determined based on the second MCS mapping relationship or the fourth MCS mapping relationship.

The second indication information is used to indicate a first QAM scheme, the third indication information is used to indicate a second QAM scheme, the first QAM scheme is different from the second QAM scheme, and the MCS mapping relationship includes at least one of: a mapping relationship, from the plurality of MCS mapping relationships, associated with the first QAM scheme, or a mapping relationship, from the plurality of MCS mapping relationships, associated with the second QAM scheme.

A value of the fourth indication information is used to indicate the MCS mapping relationship.

In some embodiments, in a case where the transmission parameter information indicates that the number of transmission layers of the channel is greater than or equal to 2, the MCS mapping indication information includes the first indication information, the second indication information, and the fourth indication information, and the fourth indication information takes a first value, the MCS information of the channel is determined based on the first MCS mapping relationship; or in a case where the transmission parameter information indicates that the number of transmission layers of the channel is greater than or equal to 2, the MCS mapping indication information includes the first indication information, the second indication information, and the fourth indication information, and the fourth indication information takes a second value, the MCS information of the channel is determined based on the third MCS mapping relationship; or in a case where the transmission parameter information indicates that the number of transmission layers of the channel is greater than or equal to 2, the MCS mapping indication information includes the first indication information, the third indication information, and the fourth indication information, and the fourth indication information takes a first value, the MCS information of the channel is determined based on the second MCS mapping relationship; or in a case where the transmission parameter information indicates that the number of transmission layers of the channel is greater than or equal to 2, the MCS mapping indication information includes the first indication information, the third indication information, and the fourth indication information, and the fourth indication information takes a second value, the MCS information of the channel is determined based on the fourth MCS mapping relationship.

In some embodiments, in the third MCS mapping relationship, a target code rate is 438 for an MCS index of 17.

In some embodiments, in the fourth MCS mapping relationship, a target code rate is 438 for an MCS index of 21; and/or a target code rate is 466 for an MCX index of 22; and/or a target code rate is 517 for an MCS index of 23.

In some embodiments, the fourth indication information is carried by RRC signaling, a MAC CE, or DCI.

In some embodiments, the second indication information and/or the third indication information is carried by RRC signaling.

In some embodiments, the second indication information and the third indication information are carried by the same RRC signaling, or the second indication information and the third indication information are carried by different RRC signaling.

In some embodiments, the first indication information is carried by at least one of: RRC signaling, a MAC CE, or DCI.

In some embodiments, the first indication information is configured in one of following parameters: msg3-transformPrecoder, msgA-TransformPrecoder, transformPrecoder in pusch-Config, or transformPrecoder in configuredGrantConfig.

In some embodiments, the second transmitting module 1101 is further configured to transmit MCS index indication information, wherein the MCS index indication information is used to determine an MCS index corresponding to the channel, and the MCS index corresponding to the channel is an MCS index of the channel in the MCS mapping relationship.

In some embodiments, the MCS information of the channel is determined based on the transmission parameter information, the MCS mapping relationship, and the MCS index; wherein the MCS information includes at least one of: a modulation order, a target code rate, or a spectral efficiency.

In some embodiments, the MCS index indication information is carried by DCI.

In some embodiments, the channel includes one PUSCH or at least two PUSCHs.

In some embodiments, the at least two PUSCHs include a first PUSCH and a second PUSCH; wherein the first PUSCH includes at least one PUSCH associated with first spatial information, the second PUSCH includes at least one PUSCH associated with second spatial information, and the first spatial information is different from the second spatial information.

In some embodiments, an MCS mapping relationship corresponding to the first PUSCH is the same as or different from an MCS mapping relationship corresponding to the second PUSCH.

In some embodiments, an MCS index corresponding to the first PUSCH is the same as or different from an MCS index corresponding to the second PUSCH.

In some embodiments, the MCS index indication information includes first MCS index indication information and second MCS index indication information; wherein the first MCS index indication information is used to determine the MCS index corresponding to the first PUSCH, and the second MCS index indication information is used to determine the MCS index corresponding to the second PUSCH.

In some embodiments, the MCS index indication information includes first MCS index indication information; wherein the first MCS index indication information is used to determine the MCS index corresponding to the first PUSCH, and the first MCS index indication information is further used with a first offset value to determine the MCS index corresponding to the second PUSCH.

In some embodiments, a value of the MCS index corresponding to the second PUSCH is a sum of the first offset value and a value of the MCS index corresponding to the first PUSCH.

In some embodiments, a transmission scheme of the channel includes an SDM scheme or an SFN scheme.

The second transmitting module 1101 is configured to perform the steps related to transmission performed by the terminal device in the above embodiments.

In some embodiments, the apparatus further includes a second receiving module 1102, configured to perform the steps related to reception performed by the terminal device in the above embodiments.

In some embodiments, the apparatus includes one second transmitting module 1101, configured to perform all the transmission steps performed by the network device in the above embodiments.

In some embodiments, the apparatus includes a plurality of second transmitting modules 1101, respectively configured to perform part of the transmission steps performed by the network device in the above embodiments.

In some embodiments, the steps performed by different second transmitting modules 1101 are completely the same, partially the same, or completely different.

In some embodiments, the apparatus includes one second receiving module 1102, configured to perform all the reception steps performed by the network device in the above embodiments.

In some embodiments, the apparatus includes a plurality of second receiving modules 1102, respectively configured to execute part of the reception steps performed by the network device in the above embodiments.

In some embodiments, the steps performed by different second receiving modules 1102 are completely the same, partially the same, or completely different.

In some embodiments, the apparatus includes a second processing module 1103, configured to perform one or more operations of encoding, modulation, demodulation, and decoding on the channel.

In view of the above, the apparatus according to the embodiments of the present disclosure supports determining different MCS mapping relationships for channels with different numbers of transmission layers. Compared with a design in the related art where the same MCS mapping table is used regardless of the number of transmission layers of the channel, the apparatus according to the present disclosure supports determining more accurate and appropriate MCS information for channels with different numbers of transmission layers. This improves the demodulation performance of the channel, enhances the coverage and transmission quality of the channel, and improves the communication efficiency of the communication system.

It should be noted that the apparatuses in the above embodiments are merely illustrated by dividing into various functional modules as examples. In practical applications, the above functions may be allocated to different functional modules as needed, that is, an internal structure of a device is divided into different functional modules to complete all or part of the functions as described above.

For the apparatuses in the above embodiments, the specific manner in which each module performs operations is described in detail in the embodiments related to the method, which is not elaborated herein.

FIG. 12 illustrates a schematic structural diagram of a communication device (terminal or network device) according to some exemplary embodiments of the present disclosure. The communication device 1200 includes: a processor 1201, a receiver 1202, a transmitter 1203, a memory 1204, and a bus 1205.

The processor 1201 includes one or more processing cores, and the processor 1201 executes various functional applications and information processing by running software programs and modules. In some embodiments, the processor 1201 may be configured to implement the functions and steps of the determination module 1011 and/or the first processing module 1014 and/or the second processing module 1103 as described above.

The receiver 1202 and the transmitter 1203 may be implemented as a communication component, which may be a communication chip. In some embodiments, the receiver 1202 may be configured to implement the functions and steps of the first receiving module 1012 and/or the second receiving module 1102 as described above. In some embodiments, the transmitter 1203 may be configured to implement the functions and steps of the first transmitting module 1013 and/or the second transmitting module 1101 as described above.

The memory 1204 is connected to the processor 1201 via the bus 1205. The memory 1204 may be configured to store at least one instruction, and the processor 1201 is configured to execute the at least one instruction to perform the steps in the above method embodiments.

In addition, the memory 1204 may be implemented by any type of volatile or non-volatile storage device or a combination thereof. The volatile or non-volatile storage devices include, but are not limited to: magnetic disks or optical disks, electrically-erasable programmable read-only memory (EEPROM), erasable programmable read-only memory (EPROM), static random-access memory (SRAM), read-only memory (ROM), magnetic memory, flash memory, and programmable read-only memory (PROM).

In some embodiments, the receiver 1202 receives signals/data independently, or the processor 1201 controls the receiver 1202 to receive signals/data, or the processor 1201 requests the receiver 1202 to receive signals/data, or the processor 1201 cooperates with the receiver 1202 to receive signals/data.

In some embodiments, the transmitter 1203 transmits signals/data independently, or the processor 1201 controls the transmitter 1203 to transmit signals/data, or the processor 1201 requests the transmitter 1203 to transmit signals/data, or the processor 1201 cooperates with the transmitter 1203 to transmit signals/data.

According to an exemplary embodiment of the present disclosure, a computer-readable storage medium is further provided. The computer-readable storage medium stores at least one program, and the at least one program is loaded and executed by the processor to perform the method for determining MCS mapping information provided in the above method embodiments.

According to an exemplary embodiment of the present disclosure, a chip is further provided. The chip includes programmable logic circuitry and/or one or more program instructions. The chip, when running on a communication device, is configured to perform the method for determining MCS mapping information provided in the above method embodiments.

According to an exemplary embodiment of the present disclosure, a computer program product is further provided. The computer program product, when running on a processor of a computer device, causes the computer device to perform the method for determining MCS mapping information as described above.

According to an exemplary embodiment of the present disclosure, a computer program is further provided. The computer program includes one or more computer instructions. The one or more computer instructions, when executed by a processor of a computer device, cause the computer device to perform the method for determining MCS mapping information as described above.

A person skilled in the art should be aware that in the foregoing one or more examples, the functions described in the embodiments of the present disclosure may be implemented by hardware, software, firmware, or any combination thereof. The functions, when implemented by software, may be stored in a computer-readable medium or transmitted as one or more instructions or codes on the computer-readable medium. The computer-readable medium includes a computer storage medium and a communication medium. The communication medium includes any medium that facilitates transfer of a computer program from one place to another. The storage medium may be any available medium accessible by a general-purpose computer or a special-purpose computer.

Described above are merely optional embodiments of the present disclosure and are not used to limit the present disclosure. Any modifications, equivalent substitutions, improvements, and the like made within the spirit and principles of the present disclosure shall be included within the protection scope of the present disclosure.

1. A method for determining modulation and coding scheme (MCS) mapping information, performed by a terminal device, the method comprising:
determining MCS information of a channel based on transmission parameter information and an MCS mapping relationship, wherein the MCS mapping relationship comprises at least one of:
a first mapping relationship comprising MCS information corresponding to a scenario where the transmission parameter information indicates that a number of transmission layers of the channel is 1; or
a second mapping relationship comprising MCS information corresponding to a scenario where the transmission parameter information indicates that a number of transmission layers of the channel is greater than or equal to 2;
wherein the first mapping relationship is different from the second mapping relationship.

2. The method according to claim 1, wherein:
prior to determining the MCS information of the channel based on the transmission parameter information and the MCS mapping relationship, the method further comprises:
receiving MCS mapping indication information, wherein the MCS mapping indication information is used to indicate the MCS mapping relationship; and
determining the MCS information of the channel based on the transmission parameter information and the MCS mapping relationship comprises:
determining the MCS information of the channel based on the transmission parameter information and the MCS mapping indication information.

3. The method according to claim 1, wherein:
the first mapping relationship comprises at least one of: a first MCS mapping relationship or a second MCS mapping relationship; and
the second mapping relationship comprises at least one of the first MCS mapping relationship, the second MCS mapping relationship, a third MCS mapping relationship, or a fourth MCS mapping relationship;
wherein the first MCS mapping relationship, the second MCS mapping relationship, the third MCS mapping relationship, and the fourth MCS mapping relationship are different from each other.

4. The method according to claim 3, wherein MCS mapping indication information comprises first indication information, wherein the first indication information is used to indicate that channel transmission is performed via precoding, and the MCS mapping relationship comprises a mapping relationship associated with the channel transmission via precoding.

5. The method according to claim 4, wherein:
in a case where the transmission parameter information indicates that the number of transmission layers of the channel is greater than or equal to 2, and the MCS mapping indication information comprises the first indication information and second indication information, the MCS information of the channel is determined based on the third MCS mapping relationship, wherein the second indication information is used to indicate a first quadrature amplitude modulation (QAM) scheme; or
in a case where the transmission parameter information indicates that the number of transmission layers of the channel is greater than or equal to 2, and the MCS mapping indication information comprises the first indication information and third indication information, the MCS information of the channel is determined based on the fourth MCS mapping relationship, wherein the third indication information is used to indicate a second QAM scheme different from the first QAM scheme;
in a case where the transmission parameter information indicates that the number of transmission layers of the channel is greater than or equal to 2, and the MCS mapping indication information comprises the first indication information, second indication information, and fourth indication information, the MCS information of the channel is determined based on the first MCS mapping relationship or the third MCS mapping relationship, wherein the second indication information is used to indicate a first QAM scheme; or
in a case where the transmission parameter information indicates that the number of transmission layers of the channel is greater than or equal to 2, and the MCS mapping indication information comprises the first indication information, third indication information, and fourth indication information, the MCS information of the channel is determined based on the second MCS mapping relationship or the fourth MCS mapping relationship, wherein the third indication information is used to indicate a second QAM scheme different from the first QAM scheme;
wherein:
the MCS mapping relationship comprises at least one of: a mapping relationship associated with the first QAM scheme, or a mapping relationship associated with the second QAM scheme; and
a value of the fourth indication information is used to indicate the MCS mapping relationship.

6. The method according to claim 5, wherein:
in a case where the transmission parameter information indicates that the number of transmission layers of the channel is greater than or equal to 2, the MCS mapping indication information comprises the first indication information, the second indication information, and the fourth indication information, and the fourth indication information takes a first value, the MCS information of the channel is determined based on the first MCS mapping relationship;
in a case where the transmission parameter information indicates that the number of transmission layers of the channel is greater than or equal to 2, the MCS mapping indication information comprises the first indication information, the second indication information, and the fourth indication information, and the fourth indication information takes a second value, the MCS information of the channel is determined based on the third MCS mapping relationship;
in a case where the transmission parameter information indicates that the number of transmission layers of the channel is greater than or equal to 2, the MCS mapping indication information comprises the first indication information, the third indication information, and the fourth indication information, and the fourth indication information takes a first value, the MCS information of the channel is determined based on the second MCS mapping relationship; or
in a case where the transmission parameter information indicates that the number of transmission layers of the channel is greater than or equal to 2, the MCS mapping indication information comprises the first indication information, the third indication information, and the fourth indication information, and the fourth indication information takes a second value, the MCS information of the channel is determined based on the fourth MCS mapping relationship.

7. The method according to claim 3, wherein:
in the third MCS mapping relationship, a target code rate is 438 for an MCS index of 17; and
in the fourth MCS mapping relationship, a target code rate is 438 for an MCS index of 21; and/or a target code rate is 466 for an MCX index of 22; and/or a target code rate is 517 for an MCS index of 23.

8. The method according to claim 5, wherein:
the fourth indication information is carried by radio resource control (RRC) signaling, a medium access control (MAC) control element (CE), or downlink control information (DCI); and
the second indication information and/or the third indication information is carried by RRC signaling, wherein the second indication information and the third indication information are carried by the same or different RRC signaling.

9. The method according to claim 4, wherein:
the first indication information is carried by at least one of: radio resource control (RRC) signaling, a medium access control (MAC) control element (CE), or downlink control information (DCI); and
the first indication information is configured in one of following parameters:
msg3-transformPrecoder,
msgA-TransformPrecoder,
transformPrecoder in pusch-Config, or
transformPrecoder in configuredGrantConfig.

10. The method according to claim 1, further comprising:
determining an MCS index corresponding to the channel based on MCS index indication information, wherein the MCS index corresponding to the channel is an MCS index of the channel in the MCS mapping relationship.

11. The method according to claim 10, wherein:
the channel comprises: one physical uplink shared channel (PUSCH), or at least two PUSCHs, wherein the at least two PUSCHs comprise:
a first PUSCH comprising at least one PUSCH associated with first spatial information; and
a second PUSCH comprising at least one PUSCH associated with second spatial information different from the first spatial information.

12. The method according to claim 11, wherein an MCS mapping relationship corresponding to the first PUSCH is the same as or different from an MCS mapping relationship corresponding to the second PUSCH.

13. The method according to claim 11, wherein an MCS index corresponding to the first PUSCH is the same as or different from an MCS index corresponding to the second PUSCH.

14. The method according to claim 13, wherein:
the MCS index indication information comprises first MCS index indication information and second MCS index indication information; and the MCS index corresponding to the first PUSCH is determined based on the first MCS index indication information, and the MCS index corresponding to the second PUSCH is determined based on the second MCS index indication information; or
the MCS index indication information comprises first MCS index indication information; and the MCS index corresponding to the first PUSCH is determined based on the first MCS index indication information, and the MCS index corresponding to the second PUSCH is determined based on the first MCS index indication information and a first offset value, wherein a value of the MCS index corresponding to the second PUSCH is a sum of the first offset value and a value of the MCS index corresponding to the first PUSCH.

15. The method according to claim 11, wherein a transmission scheme of the channel comprises a space-division multiplexing (SDM) scheme or a single-frequency network (SFN) scheme.

16. A network device, comprising:
a processor;
a transceiver communicably connected to the processor; and
a memory for storing one or more instructions executable by the processor;
wherein the processor is configured to execute the one or more instructions to:
transmit transmission parameter information, wherein the transmission parameter information is used with an MCS mapping relationship to determine MCS information of a channel, wherein the MCS mapping relationship comprises at least one of:
a first mapping relationship comprising MCS information corresponding to a scenario where the transmission parameter information indicates that a number of transmission layers of the channel is 1; or
a second mapping relationship comprising MCS information corresponding to a scenario where the transmission parameter information indicates that a number of transmission layers of the channel is greater than or equal to 2;
wherein the first mapping relationship is different from the second mapping relationship.

17. The network device according to claim 16, wherein the processor is further configured to load and execute the one or more instructions to:
transmit MCS mapping indication information, wherein the MCS mapping indication information is used to indicate the MCS mapping relationship.

18. The network device according to claim 16, wherein the processor is further configured to load and execute the one or more instructions to:
transmit MCS index indication information, wherein the MCS index indication information is used to determine an MCS index corresponding to the channel, and the MCS index corresponding to the channel is an MCS index of the channel in the MCS mapping relationship.

19. The network device according to claim 18, wherein:
the MCS information of the channel is determined based on the transmission parameter information, the MCS mapping relationship, and the MCS index; and
the MCS information comprises at least one of: a modulation order, a target code rate, or a spectral efficiency.

20. The network device according to claim 18, wherein the MCS index indication information is carried by downlink control information (DCI).
